(19) United States
(12) Patent Application Publication
(10) Pub. No.: US 2026/0213182 A1
(43) Pub. Date: Jul. 23, 2026

(54) POSITIVE ELECTRODE ACTIVE MATERIAL, POSITIVE ELECTRODE, SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Atsushi KAWATSUKI, Yokohama , Kanagawa (JP); Jo SAITO, Atsugi, Kanagawa (JP); Mayumi MIKAMI, Atsugi, Kanagawa (JP)

(21) Appl. No.: 19/140,651

(22) PCT Filed: Jan. 30, 2024
(86) PCT No.: PCT/IB2024/050823

§ 371 Date: Jun. 18, 2025

(30) Foreign Application Priority Data
Feb. 3, 2023 (JP) 2023-015015

(51) Int. Cl. H01M 4/525; H01M 4/02; H01M 4/131; H01M 10/052

(52) U.S. Cl. CPC H01M 4/525; H01M 4/131; H01M 10/052; H01M 2004/021; H01M 2004/028; H01M 2200/20; H01M 2220/20

(57) ABSTRACT

A highly safe or highly reliable secondary battery having high charge and discharge capacity is provided. Alternatively, a positive electrode active material which inhibits a decrease in discharge capacity during charge and discharge cycles and a secondary battery using the positive electrode active material are provided. The secondary battery includes the positive electrode active material including cobalt, in which the powder volume resistivity of the positive electrode active material under a pressure of 64 MPa is higher than or equal to 5.0×10³ Ω·cm and lower than or equal to 1.0×10¹² Ω·cm. The positive electrode active material includes magnesium, nickel, and aluminum in a surface portion. The surface portion is a region extending from a surface of the positive electrode active material to a depth of 50 nm or less. The positive electrode active material includes a region where magnesium and nickel are distributed closer to the surface of the positive electrode active material than aluminum is when EDX line analysis in the depth direction is performed.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Note that an electronic device in this specification means all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, crystal structures of positive electrode active materials have been studied (Non-Patent Document 1 to Non-Patent Document 3). Furthermore, powder resistance or conductivity of a positive electrode active material has also been studied (Patent Document 4 to Patent Document 6).

In addition, X-ray diffraction (XRD) is one of methods used for analysis of the crystal structure of a positive electrode active material. With the use of ICSD (Inorganic Crystal Structure Database) described in Non-Patent Document 4, XRD data can be analyzed. For Rietveld analysis, the analysis program RIETAN-FP (Non-Patent Document 5) can be used, for example.

### REFERENCES

### Patent Documents

[Patent Document 1] Japanese Published Patent Application No. 2019-179758
[Patent Document 2] WO2020/026078 Pamphlet
[Patent Document 3] Japanese Published Patent Application No. 2022-070247
[Patent Document 4] Japanese Published Patent Application No. 2019-212400
[Patent Document 5] Japanese Published Patent Application No. 2009-081130
[Patent Document 6] Japanese Published Patent Application No. 2014-241300

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2]T. Motohashi, et al, “Electronic phase diagram of the layered cobalt oxide system LiₓCoO₂ (0.0≤x≤1.0)”, Physical Review B, 80 (16); 165114
[Non-Patent Document 3] Zhaohui Chen et al, “Staging Phase Transitions in LiₓCoO₂”, Journal of The Electrochemical Society, 2002, 149 (12) A1604-A1609
[Non-Patent Document 4]A. Belsky, et al., “New developments in the Inorganic Crystal Structure Database (ICSD): accessibility in support of materials research and design”, Acta Cryst. Section B, (2002) B58 364-369.
[Non-Patent Document 5]F. Izumi and K. Momma, Solid State Phenom., (2007) 130, 15-20
[Non-Patent Document 6]R. D. Shannon et al., “Revised effective ionic radii and systematic studies of interatomic distances in halides and chalcogenides”, Acta Cryst. Section A, (1976) 32 751.

### SUMMARY OF THE INVENTION

### Problems to be Solved by the Invention

There is room for improvements in a variety of aspects of lithium-ion secondary batteries, such as discharge capacity, cycle performance, reliability, safety, and cost.

One object of one embodiment of the present invention is to provide a highly safe or reliable secondary battery having high charge and discharge capacity. Another object is to provide a secondary battery in which a decrease in charge and discharge capacity during charge and discharge cycles is inhibited. Another object is to provide a positive electrode active material or a composite oxide which can be used in a lithium-ion secondary battery and inhibits a decrease in discharge capacity during charge and discharge cycles. Another object is to provide a positive electrode active material or a composite oxide whose crystal structure is not easily broken even when charging and discharging are repeated. Another object is to provide a positive electrode active material or a composite oxide with high discharge capacity.

Another object of one embodiment of the present invention is to provide a positive electrode active material, a composite oxide, a power storage device, or a manufacturing method thereof.

Note that the description of these objects does not preclude the existence of other objects. Note that one embodiment of the present invention does not need to achieve all of these objects. Note that other objects can be derived from the description of the specification, the drawings, and the claims.

### Means for Solving the Problems

In order to solve the above problems, a positive electrode active material having high powder resistance (also referred to as volume resistivity in a powder) is provided in one embodiment of the present invention. When the powder resistance of the positive electrode active material is increased, current at the time of short circuit can be inhibited even when the secondary battery is short-circuited. Accordingly, a highly safe secondary battery can be provided.

In order to increase the powder resistance of the positive electrode active material, the surface portion of the positive electrode active material preferably includes an additive element. As the additive element, one or two or more selected from magnesium, fluorine, nickel, aluminum, zirconium, vanadium, iron, manganese, chromium, niobium, arsenic, zinc, silicon, sulfur, phosphorus, boron, bromine, and beryllium is preferably used.

When the above additive element is included at a preferable concentration, the surface and the surface portion of the positive electrode active material can be electrochemically stabilized. Accordingly, a decrease in charge and discharge capacity during charge and discharge cycles can be inhibited.

One embodiment of the present invention is a positive electrode active material including cobalt, in which the powder volume resistivity of the positive electrode active material measured under a pressure of 64 MPa is higher than or equal to 5.0×10³ Ω·cm and lower than or equal to 1.0×10¹² Ω·cm.

In the above, particle size distribution of the powder of the positive electrode active material preferably has a median diameter of greater than or equal to 7 μm and less than or equal to 12 μm, and the positive electrode active material preferably includes magnesium, nickel, and aluminum.

In the above, the positive electrode active material preferably has a layered rock-salt crystal structure belonging to the space group R-3m.

In the above, the positive electrode active material includes magnesium, nickel, and aluminum in the surface portion; the surface portion is a region extending from the surface of the positive electrode active material to a depth of 50 nm or less; the positive electrode active material preferably includes a region where the magnesium and the nickel are distributed closer to the surface of the positive electrode active material than the aluminum is when an EDX line analysis in a depth direction is performed.

In the above, it is preferable that the surface portion include a basal region having a surface parallel to the (00/) plane of the crystal structure and an edge region having a surface in a direction intersecting with the (00/) plane, and in the basal region, the distribution of aluminum attenuate to 50% of the peak at a depth of 25 nm or less from the surface of the positive electrode active material when an EDX line analysis in a depth direction is performed.

Another embodiment of the present invention is a positive electrode including the positive electrode active material described in any one of the above embodiments.

Another embodiment of the present invention is a secondary battery including the positive electrode described above.

Another embodiment of the present invention is an electronic device including the secondary battery described above. Another embodiment is a vehicle including the secondary battery described above.

### Effect of the Invention

According to one embodiment of the present invention, a highly safe or highly reliable secondary battery can be provided. Alternatively, a positive electrode active material or a composite oxide which can be used in a lithium-ion secondary battery and inhibits a decrease in discharge capacity during charge and discharge cycles can be provided. Alternatively, a positive electrode active material or a composite oxide whose crystal structure is not easily broken even when charging and discharging are repeated can be provided. Alternatively, a positive electrode active material or a composite oxide with high discharge capacity can be provided.

Another embodiment of the present invention can provide a positive electrode active material, a composite oxide, a power storage device, or a manufacturing method thereof.

Note that the description of these effects does not preclude the existence of other effects. Note that one embodiment of the present invention does not need to have all of these effects. Note that other effects will be apparent from the description of the specification, the drawings, the claims, and the like and other effects can be derived from the description of the specification, the drawings, the claims, and the like.

### BRIEF DESCRIPTION OF THE DRAWINGS

FIG. 1A and FIG. 1B are cross-sectional views of a positive electrode active material, and FIG. 1C to FIG. 1F are cross-sectional views of part of the positive electrode active material.

FIG. 2 is a diagram showing crystal structures of a positive electrode active material.

FIG. 3 is a diagram showing crystal structures of a conventional positive electrode active material.

FIG. 4 is a diagram showing XRD patterns calculated from crystal structures.

FIG. 5 is a diagram showing XRD patterns calculated from crystal structures.

FIG. 6A and FIG. 6B are diagrams showing XRD patterns calculated from crystal structures.

FIG. 7A to FIG. 7C are diagrams showing a method for manufacturing a positive electrode active material.

FIG. 8 is a diagram showing a method for manufacturing a positive electrode active material.

FIG. 9A to FIG. 9C are diagrams showing the method for manufacturing a positive electrode active material.

FIG. 10A to FIG. 10D are cross-sectional views illustrating examples of a positive electrode of a secondary battery.

FIG. 11A and FIG. 11B are diagrams illustrating examples of a secondary battery.

FIG. 12A is an exploded perspective view of a coin-type secondary battery, FIG. 12B is a perspective view of the coin-type secondary battery, and FIG. 12C is a cross-sectional perspective view thereof.

FIG. 13A illustrates an example of a cylindrical secondary battery. FIG. 13B illustrates an example of the cylindrical secondary battery. FIG. 13C illustrates an example of a plurality of cylindrical secondary batteries. FIG. 13D illustrates an example of a power storage system including the plurality of cylindrical secondary batteries.

FIG. 14A and FIG. 14B are diagrams illustrating examples of a secondary battery, and FIG. 14C is a diagram illustrating the internal state of the secondary battery.

FIG. 15A to FIG. 15C are diagrams each illustrating an example of a secondary battery.

FIG. 16A and FIG. 16B are diagrams each illustrating an external view of a secondary battery.

FIG. 17A to FIG. 17C are diagrams illustrating a method for manufacturing a secondary battery.

FIG. 18A to FIG. 18C are diagrams illustrating structure examples of a battery pack.

FIG. 19A is a perspective view of a battery pack of one embodiment of the present invention, FIG. 19B is a block diagram of the battery pack, and FIG. 19C is a block diagram of a vehicle including the battery pack.

FIG. 20A to FIG. 20D are diagrams each illustrating an example of a transport vehicle. FIG. 20E is a diagram illustrating an example of an artificial satellite.

FIG. 21A and FIG. 21B are diagrams each illustrating a power storage device of one embodiment of the present invention.

FIG. 22A is a diagram illustrating an electric bicycle, FIG. 22B is a diagram illustrating a secondary battery of an electric bicycle, and FIG. 22C is a diagram illustrating a scooter.

FIG. 23A to FIG. 23D are diagrams each illustrating an example of an electronic device.

FIG. 24A illustrates examples of wearable devices, FIG. 24B is a perspective view of a watch-type device, and FIG. 24C is a diagram illustrating a side surface of the watch-type device.

FIG. 25 is a graph showing particle size distribution described in Example 1.

FIG. 26A and FIG. 26B are graphs each showing a STEM-EDX analysis described in Example 1.

FIG. 27A to FIG. 27C are graphs each showing a STEM-EDX analysis described in Example 1.

FIG. 28A to FIG. 28C are graphs each showing a STEM-EDX analysis described in Example 1.

FIG. 29A to FIG. 29C are graphs each showing charge-discharge cycle performance described in Example 2.

FIG. 30A to FIG. 30C are graphs each showing charge-discharge cycle performance described in Example 2.

FIG. 31A and FIG. 31B are graphs each showing the relation between charge-discharge cycle performance and powder resistance described in Example 2.

### MODE FOR CARRYING OUT THE INVENTION

Embodiment examples for carrying out the present invention will be described below with reference to the drawings and the like. Note that the present invention should not be interpreted as being limited to the embodiment examples given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure in some cases. In this specification and the like, a crystal plane or the like in the space group R-3m is represented with use of a composite hexagonal lattice, unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, a powder refers to a group of a plurality of particles. Unless otherwise specified, the powder resistance (also referred to as volume resistivity in a powder) of the positive electrode active material refers to the powder resistance of the positive electrode active material that has not undergone the electrode manufacture and charge and discharge step. This is because the surface state of the positive electrode active material might be changed and the resistivity might be changed through the charge and discharge step or the like.

A theoretical capacity of a positive electrode active material refers to the amount of electricity obtained when all lithium that can be inserted and extracted and is included in the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24.

Lithium cobalt oxide to be used for a positive electrode, which has been appropriately synthesized and almost satisfies the stoichiometric proportion, is LiCoO₂ with x=1. In a secondary battery after its discharging ends, it can be said that included lithium cobalt oxide is also LiCoO₂ with x=1. Here, “discharging ends” means that a voltage becomes 3.0 V or 2.5 V or lower at a current of 100 mAh or lower, for example.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

The distribution of an element refers to a region where the element is successively detected by a successive analysis method to the extent that the detection value is no longer on the noise level. The region where the element is successively detected to the extent that the detection value is no longer on the noise level can be rephrased as, for example, a region where the element is surely detected when the analysis is performed a plurality of times.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charging and discharging.

A short circuit of a secondary battery might cause not only malfunction in charge operation and/or discharge operation of the secondary battery but also heat generation and firing. In order to obtain a safe secondary battery, a short circuit is preferably inhibited even at a high charge voltage. In the positive electrode active material of one embodiment of the present invention, a short circuit is inhibited even at a high charge voltage. Thus, a secondary battery having a high discharge capacity and a high level of safety can be obtained.

### Embodiment 1

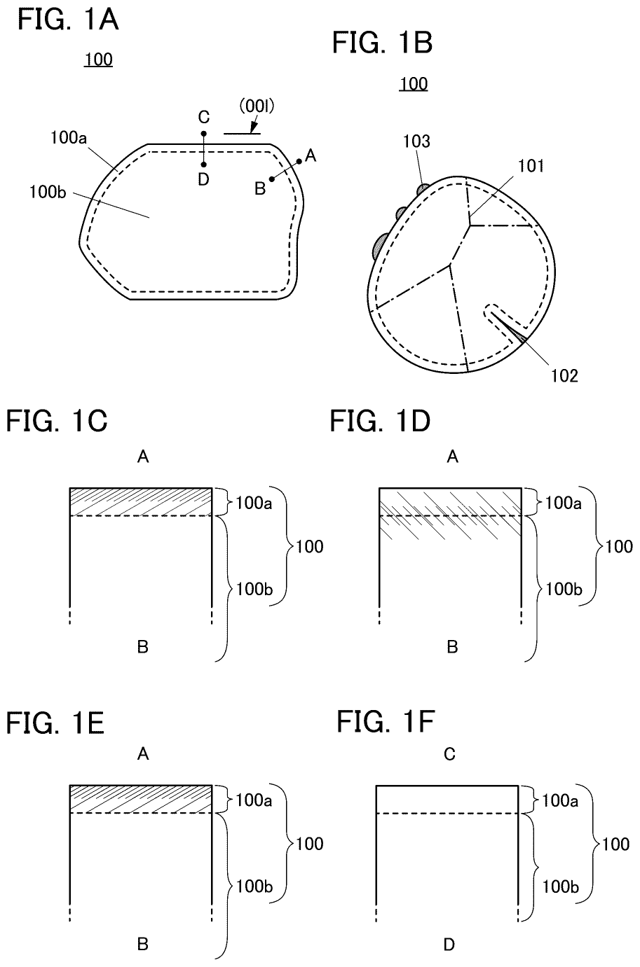

In this embodiment, a positive electrode active material 100 of one embodiment of the present invention will be described with reference to FIG. 1 to FIG. 6.

FIG. 1A and FIG. 1B are each a cross-sectional view of the positive electrode active material 100 of one embodiment of the present invention. FIG. 1C to FIG. 1E illustrate enlarged views of the vicinity of A-B in FIG. 1A. FIG. 1F illustrates an enlarged view of the vicinity of C-D in FIG. 1A.

As illustrated in FIG. 1A to FIG. 1F, the positive electrode active material 100 includes a surface portion 100a and an inner portion 100b. In each drawing, the dashed line denotes a boundary between the surface portion 100a and the inner portion 100b. In FIG. 1B, the dashed-dotted line denotes part of a crystal grain boundary 101.

In this specification and the like, the surface portion 100a of the positive electrode active material 100 refers to a region extending from the surface toward the inner portion, in a perpendicular direction or a substantially perpendicular direction, to a depth of 50 nm or less, preferably 35 nm or less, further preferably 20 nm or less, and most preferably 10 nm or less. Note that “substantially perpendicular” refers to being at greater than or equal to 800 and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

The surface of the positive electrode active material 100 refers to a surface of a composite oxide including the surface portion 100a and the inner portion 100b. Thus, the positive electrode active material 100 does not include a material to which a metal oxide that does not include a lithium site contributing to charging and discharging, such as aluminum oxide (Al₂O₃), is attached, or a carbonate, a hydroxy group, or the like which is chemically adsorbed after manufacture of the positive electrode active material. The material to which a metal oxide is attached refers to, for example, a metal oxide having a crystal structure different from that of the inner portion 100b.

Furthermore, the positive electrode active material 100 does not include an electrolyte, an organic solvent, a binder, a conductive material, and a compound originating from any of these that are attached to the surface of the positive electrode active material 100.

Since the positive electrode active material 100 is a compound including oxygen and a transition metal into and from which lithium can be inserted and extracted, an interface between a region where oxygen and a transition metal M(Co, Ni, Mn, Fe, or the like) that becomes oxidized or reduced by insertion and extraction of lithium are present and a region where oxygen and the transition metal M are absent can be considered as the surface of the positive electrode active material. A plane generated by slipping, a split, and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Powder Resistance>

The positive electrode active material 100 preferably has high volume resistivity in a powder. When the powder resistance is increased, current at the time of short circuit can be inhibited even when the secondary battery is short-circuited. Accordingly, a highly safe secondary battery can be provided. Meanwhile, when the powder resistance of the positive electrode active material 100 is too high, the internal resistance of the secondary battery is increased and a sufficient charge and discharge capacity cannot be obtained in some cases.

Thus, in one embodiment of the present invention, the volume resistivity in a powder of the positive electrode active material 100 measured under a pressure of 64 MPa is preferably higher than or equal to 5.0×10³ Ω·cm and lower than or equal to 1.0×10¹² Ω·cm, further preferably higher than or equal to 1.0×10⁷ Ω·cm and lower than or equal to 1.0×10¹⁰ Ω·cm, still further preferably higher than or equal to 2.0×10⁸ Ω·cm and lower than or equal to 1.0×10¹⁰ Ω·cm, most preferably higher than or equal to 1.0×10⁹ Ω·cm and lower than or equal to 1.0×10¹⁰ Ω·cm.

The volume resistivity in a powder of the positive electrode active material 100 measured under a pressure of 51 MPa is preferably higher than or equal to 5.0×10³ Ω·cm and lower than or equal to 1.0×10¹² Ω·cm, further preferably higher than or equal to 5.0×10⁷ Ω·cm and lower than or equal to 1.0×10¹⁰ Ω·cm, still further preferably higher than or equal to 3.0×10⁸ Ω·cm and lower than or equal to 1.0×10¹⁰ Ω·cm, most preferably higher than or equal to 1.0×10⁹ Ω·cm and lower than or equal to 1.0×10¹⁰ Ω·cm.

The volume resistivity in a powder of the positive electrode active material 100 measured under a pressure of 38 MPa is preferably higher than or equal to 5.0×10³ Ω·cm and lower than or equal to 1.0×10¹² Ω·cm, further preferably higher than or equal to 8.0×10⁷ Ω·cm and lower than or equal to 1.0×10¹⁰ Ω·cm, still further preferably higher than or equal to 5.0×10⁸ Ω·cm and lower than or equal to 1.0×10¹⁰ Ω·cm, most preferably higher than or equal to 5.0×10⁹ Ω·cm and lower than or equal to 1.0×10¹⁰ Ω·cm.

The volume resistivity in a powder of the positive electrode active material 100 under a pressure of 25 MPa is preferably higher than or equal to 5.0×10³ Ω·cm and lower than or equal to 1.0×10¹² Ω·cm, further preferably higher than or equal to 1.0×10⁸ Ω·cm and lower than or equal to 5.0×10¹⁰ Ω·cm, still further preferably higher than or equal to 9.0×10⁸ Ω·cm and lower than or equal to 5.0×10¹⁰ Ω·cm, most preferably higher than or equal to 5.0×10⁹ Ω·cm and lower than or equal to 5.0×10¹⁰ Ω·cm.

The volume resistivity in a powder of the positive electrode active material 100 under a pressure of 13 MPa is preferably higher than or equal to 1.0×10⁴ Ω·cm and lower than or equal to 1.0×10¹² Ω·cm, further preferably higher than or equal to 1.0×10⁸ Ω·cm and lower than or equal to 1.0×10¹¹ Ω·cm, still further preferably higher than or equal to 2.0×10⁹ Ω·cm and lower than or equal to 1.0×10¹¹ Ω·cm, most preferably higher than or equal to 2.0×10¹⁰ Ω·cm and lower than or equal to 1.0×10¹¹ Ω·cm.

### <Included Element and Distribution>

To obtain the positive electrode active material 100 having volume resistivity in the above range, the composition of the surface portion 100a is preferably different from that of the inner portion 100b. For example, the amount of additive elements included is preferably larger in the surface portion 100a than in the inner portion 100b.

The positive electrode active material 100 preferably includes lithium, cobalt, oxygen, and an additive element. The positive electrode active material 100 preferably has a layered rock-salt crystal structure belonging to the space group R-3m. Alternatively, the positive electrode active material 100 can include lithium cobalt oxide (LiCoO₂) to which an additive element is added. Note that it is permissible as long as the positive electrode active material 100 of one embodiment of the present invention has a crystal structure described later at the time of charging. Thus, the composition of the lithium cobalt oxide is not strictly limited to Li:Co:O=1:1:2.

A positive electrode active material of a lithium-ion secondary battery needs to include a transition metal M which can be oxidized or reduced in order to maintain a neutrally charged state even when lithium ions are inserted and extracted. It is preferable that the positive electrode active material 100 of one embodiment of the present invention mainly include cobalt as the transition metal M taking part in an oxidation-reduction reaction. In addition to cobalt, at least one or two selected from nickel and manganese may be used. When cobalt is used as the transition metal M included in the positive electrode active material 100 at greater than or equal to 75 atomic %, preferably greater than or equal to 90 atomic %, further preferably greater than or equal to 95 atomic %, many advantages such as relatively easy synthesis, easy handling, and excellent cycle performance are gained, which is preferable.

When cobalt is used as the transition metal M included in the positive electrode active material 100 at higher than or equal to 75 atomic %, preferably higher than or equal to 90 atomic %, further preferably higher than or equal to 95 atomic %, LiₓCO₂ with small x is more stable than a composite oxide in which nickel accounts for the majority of the transition metal M, such as lithium nickel oxide (LiNiO₂). This is probably because the influence of distortion by the Jahn-Teller effect is smaller in the case of using cobalt than in the case of using nickel.

As the additive element included in the positive electrode active material 100, one or two or more selected from magnesium, fluorine, nickel, aluminum, zirconium, vanadium, iron, manganese, chromium, niobium, arsenic, zinc, silicon, sulfur, phosphorus, boron, bromine, and beryllium is preferably used. The total percentage of the transition metal among the additive elements is preferably less than 25 atomic %, further preferably less than 10 atomic %, still further preferably less than 5 atomic %.

That is, the positive electrode active material 100 can include lithium cobalt oxide to which magnesium and fluorine are added, lithium cobalt oxide to which magnesium and fluorine are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element preferably forms a solid solution with the positive electrode active material 100. Thus, in STEM-EDX line analysis, for example, a depth at which the amount of the detected additive element increases is preferably at a deeper position than a depth at which the amount of the detected transition metal M increases, i.e., on the inner portion side of the positive electrode active material 100.

In this specification and the like, a depth at which the amount of a detected element increases in STEM-EDX line analysis refers to a depth at which a measured value, which can be determined not to be a noise in terms of intensity, spatial resolution, and the like, is successively obtained.

These additive elements further stabilize the crystal structure of the positive electrode active material 100 as described later. In this specification and the like, the additive element can be rephrased as part of a raw material or a mixture.

Note that as the additive element, magnesium, fluorine, nickel, aluminum, zirconium, vanadium, iron, manganese, chromium, niobium, arsenic, zinc, silicon, sulfur, phosphorus, boron, bromine, or beryllium is not necessarily included.

For example, when the positive electrode active material 100 is substantially free from manganese, the above advantages such as relatively easy synthesis, easy handling, and excellent cycle performance are enhanced. The weight of manganese included in the positive electrode active material 100 is preferably less than or equal to 600 ppm, further preferably less than or equal to 100 ppm, for example.

The positive electrode active material 100 that does not substantially include titanium is preferable because of increasing the powder resistance; thus, a safer secondary battery can be expected. The weight of titanium included in the positive electrode active material 100 is preferably less than or equal to 450 ppm, further preferably less than or equal to 100 ppm, for example.

The surface portion 100a of the positive electrode active material 100 preferably includes one or two or more selected from the above additive elements, further preferably includes two or more selected from the above additive elements. The surface portion 100a preferably has a higher concentration of one or two or more selected from the additive elements than the inner portion 100b. It is preferable that the one or two or more selected from the additive elements included in the positive electrode active material 100 have a concentration gradient. In the case where the positive electrode active material 100 includes a plurality of additive elements, the distributions of the additive elements are further preferably different from each other. For example, it is further preferable that the additive elements exhibit concentration peaks at different depths from the surface. The concentration peak here refers to the local maximum value of the concentration in the surface portion 100a or a region ranging from the surface to a depth of 50 nm or less.

Distribution of the additive elements is described. FIG. 1C to FIG. 1E are enlarged views of the vicinity of A-B in FIG. 1A. FIG. 1F is an enlarged view of the vicinity of C-D in FIG. 1A.

For example, as illustrated in FIG. 1C by the hatching density, some of the additive elements such as magnesium, fluorine, nickel, silicon, phosphorus, boron, calcium, and barium preferably have a concentration gradient in which the concentration increases from the inner portion 100b toward the surface. An additive element having such a concentration gradient is referred to as an additive element X.

Another additive element such as aluminum or manganese preferably has a concentration gradient as illustrated in FIG. 1D by the hatching density and exhibits a concentration peak in a deeper region than the additive element X. The concentration peak may be located in the surface portion 100a or located deeper than the surface portion 100a. For example, the concentration peak is preferably located in a region to greater than or equal to 5 nm and less than or equal to 30 nm from the surface toward the inner portion. An additive element having such a concentration gradient is referred to as an additive element Y.

Note that some of the additive elements X, such as nickel and barium, clearly exist in the vicinity of A-B in FIG. 1A as indicated by hatching in FIG. 1E. On the other hand, as the absence of hatching in FIG. 1F indicates, those additive elements X are substantially absent from the vicinity of C-D in FIG. 1A in some cases, which is different from the other additive elements X. Note that here, “clearly exist” means a case where the energy spectrum of characteristic X-rays of the element is detected in cross-sectional STEM-EDX analysis of the positive electrode active material 100.

In addition, “substantially absent” means a case where the energy spectrum of characteristic X-rays of the element is not detected in cross-sectional STEM-EDX analysis of the positive electrode active material 100. In that case, it can also be said that the element is less than or equal to the lower detection limit in STEM-EDX analysis.

Note that the vicinity of A-B in FIG. 1A can be referred to as an edge region. The vicinity of C-D in FIG. 1A can be referred to as a basal region. Note that in FIG. 1A, the straight line denoted by (00/) represents a (00/) plane. Here, the edge region has a surface exposed in a direction intersecting the (00/) plane, and the edge region refers to a region to less than or equal to 50 nm, preferably less than or equal to 35 nm, further preferably less than or equal to 20 nm, and most preferably less than or equal to 10 nm from the surface toward the inner portion in a direction perpendicular or substantially perpendicular to the surface. Here, “intersect” means that an angle between a line perpendicular to a first plane (the (00/) plane) and a line normal to a second plane (a surface of the positive electrode active material 100) is greater than or equal to 100 and less than or equal to 90°, preferably greater than or equal to 300 and less than or equal to 90°.

Moreover, the basal region has a surface parallel to the (00/) plane, and the basal region refers to a region to less than or equal to 50 nm, preferably less than or equal to 35 nm, further preferably less than or equal to 20 nm, and most preferably less than or equal to 10 nm from the surface toward the inner portion in a direction perpendicular or substantially perpendicular to the surface. Here, “parallel” means that an angle between the line perpendicular to the first plane (the (00/) plane) and the line normal to the second plane (the surface of the positive electrode active material 100) is greater than or equal to 0° and less than 10°, preferably greater than or equal to 0° and less than or equal to 5°.

The concentration of the additive element X and the concentration of the additive element Y may differ between the above basal region and the above edge region. For example, the concentration of the additive element X in the above edge region is preferably higher than the concentration of the additive element X in the above basal region. The concentration of the additive element Y in the above edge region is preferably higher than the concentration of the additive element Yin the above basal region. The above edge region is a region where many end portions of lithium layers are exposed in the layered rock-salt crystal structure of lithium cobalt oxide; thus, it is preferable that a large amount of the additive element X exist in the above edge region and a large amount of the additive element Y exist in the above edge region, in which case the positive electrode active material 100 is reinforced.

The concentration of the additive element may be compared using the ratio of the additive element to cobalt. The ratio of the additive element to cobalt is preferably used, in which case comparison can be performed while reducing the influence of a carbonate or the like that is chemically adsorbed after formation of the positive electrode active material.

### [Magnesium]

Magnesium, which is an example of the additive element X, is divalent, and a magnesium ion is more stable in lithium sites than in cobalt sites in the layered rock-salt crystal structure and thus is likely to enter the lithium sites. An appropriate concentration of magnesium in the lithium sites of the surface portion 100a can facilitate the maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium can also be expected to increase the density of the positive electrode active material 100. In addition, a high concentration of magnesium in the surface portion 100a can be expected to increase the corrosion resistance to hydrofluoric acid generated by the decomposition of an electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably includes an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. Here, the amount of magnesium included in the entire positive electrode active material 100 may be a value obtained by element analysis on the entire positive electrode active material 100 with GD-MS, ICP-MS, or the like or may be a value based on the ratio of the raw materials compounded in the process of manufacturing the positive electrode active material 100, for example.

### [Nickel]

Nickel, which is an example of the additive element X, can exist in both the cobalt site and the lithium site.

When nickel exists in lithium sites, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel in the lithium sites serves as a column supporting the CoO₂ layers. Thus, in particular, the crystal structure can be expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO and CoO, and the orientations of NiO and LiCoO₂ are likely to be aligned with each other.

Ionization tendency decreases in the order of magnesium, aluminum, cobalt, and nickel (Mg>Al>Co>Ni). Therefore, it can be considered that in charging, nickel is not easily dissolved into an electrolyte solution than the other elements described above. Accordingly, nickel can be considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Therefore, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably includes an appropriate amount of nickel. For example, the number of nickel atoms included in the positive electrode active material 100 is preferably greater than 0 and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0 and less than or equal to 4% of the number of cobalt atoms. Alternatively, it is preferably greater than 0% and less than or equal to 2% of the number of cobalt atoms. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials compounded in the process of manufacturing the positive electrode active material, for example.

Note that nickel selectively exists in the edge region of the surface portion 100a in some cases.

### [Aluminum]

Aluminum, which is an example of the additive element Y, can exist in the cobalt site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting dissolution of cobalt around aluminum and improving continuous charge tolerance. Moreover, an Al—O bond is stronger than a Co—O bond and thus extraction of oxygen around aluminum can be inhibited. These effects improve thermal stability. Hence, a secondary battery including the positive electrode active material 100 including aluminum as the additive element can have improved safety. Furthermore, the positive electrode active material 100 can have a crystal structure that is unlikely to be broken even with repeated charging and discharging.

Meanwhile, excess aluminum might adversely affect insertion and extraction of lithium.

Thus, the entire positive electrode active material 100 preferably includes an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum included in the entire positive electrode active material 100 may be a value obtained by element analysis on the entire positive electrode active material 100 with GD-MS, ICP-MS, or the like or may be a value based on the ratio of the raw materials compounded in the process of manufacturing the positive electrode active material 100, for example.

### [Fluorine]

Fluorine, which is an example of the additive element X, is a monovalent anion; when fluorine is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the other additive element source.

### [Synergistic Effect of a Plurality of Elements]

When the surface portion 100a includes both magnesium and nickel, divalent nickel can exist more stably in the vicinity of divalent magnesium. Thus, dissolution of magnesium might be inhibited even when x in LiₓCoO₂ is small. This can contribute to stabilization of the surface portion 100a.

For a similar reason, when the additive element is added to lithium cobalt oxide in the manufacture process, magnesium is preferably added in a step before addition of nickel. Alternatively, magnesium and nickel are preferably added in the same step. Magnesium has a large ion radius and thus is likely to remain in the surface portion of lithium cobalt oxide regardless of in which step magnesium is added, but nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed, such as the additive element X and the additive element Y, are preferably included at a time, in which case the crystal structure of a wider region can be stabilized. For example, in the case where the positive electrode active material 100 includes magnesium and nickel, which are examples of the additive elements X, and includes aluminum, which is one of the additive elements Y, the crystal structure of a wider region can be stabilized as compared with the case where only the additive element X or the additive element Y is included. In the case where the positive electrode active material 100 includes both the additive element X and the additive element Yas described above, the surface can be sufficiently stabilized by the additive element X such as magnesium or nickel; thus, the additive element Y such as aluminum is not necessary for the surface. It is preferable that aluminum be widely distributed in a deeper region. For example, it is preferable that aluminum be continuously detected in a region to greater than or equal to 1 nm and less than or equal to 25 nm from the surface in a depth direction. Aluminum is preferably widely distributed in a region to greater than or equal to 0 nm and less than or equal to 100 nm, further preferably greater than or equal to 0.5 nm and less than or equal to 50 nm from the surface, in which case the crystal structure of a wider region can be stabilized.

When a plurality of the additive elements are included as described above, the effects of the additive elements contribute synergistically to further stabilization of the surface portion 100a. In particular, magnesium, nickel, and aluminum are preferably included because a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, it is necessary that the surface portion 100a include at least cobalt, also include lithium in a discharged state, and have a path through which lithium is inserted and extracted.

To secure the sufficient path through which lithium is inserted and extracted, the concentration of cobalt is preferably higher than that of magnesium in the surface portion 100a. For example, the ratio of the number of magnesium atoms Mg to the number of cobalt atoms Co (Mg/Co) is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is preferably higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably less than or equal to one-sixth that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are included, a synergistic effect of suppressing dissolution of magnesium can be expected in a manner similar to the above.

### <Crystal Structure>

<<x in LiₓCoO₂ being 1>>

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

The positive electrode active material 100 of one embodiment of the present invention has a stable crystal structure even at a high voltage particularly due to the distribution of the additive element in the surface portion 100a, as described later. The stable crystal structure of the positive electrode active material in a charged state can inhibit a decrease in charge and discharge capacity due to repeated charging and discharging. In other words, the positive electrode active material 100 having the above-described high volume resistivity is an indicator of the positive electrode active material 100 having a stable crystal structure even at a high voltage and including the surface portion 100a, which is important for the stable crystal structure of the positive electrode active material in a charged state.

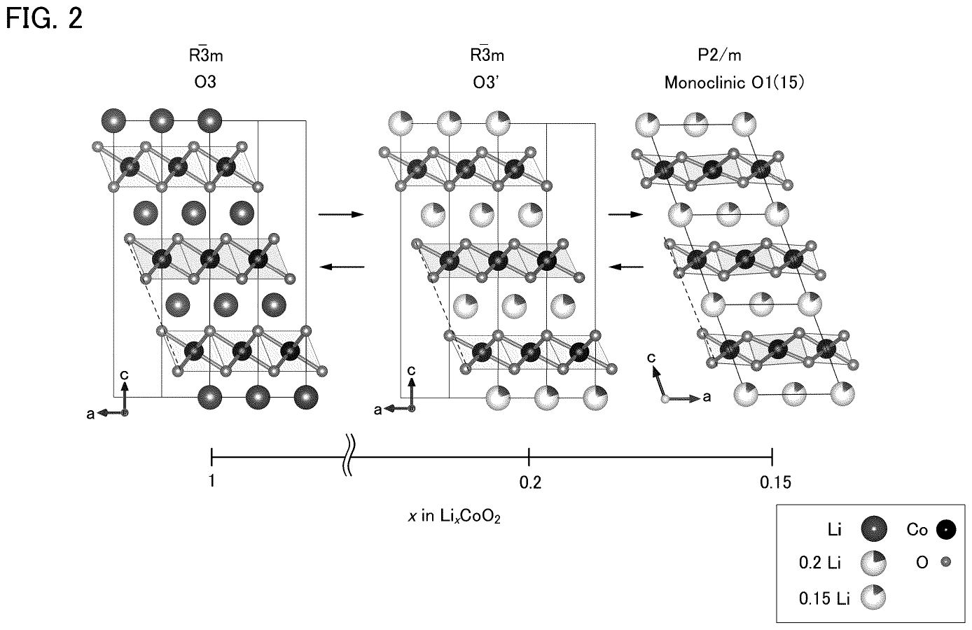

The positive electrode active material 100 of one embodiment of the present invention preferably has a layered rock-salt crystal structure belonging to the space group R-3m in a discharged state, i.e., in the case where x in LiₓCoO₂ is 1. A composite oxide having a layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 2, the layered rock-salt crystal structure is denoted by R-3m O3.

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100, such as extraction of oxygen, and/or inhibition of oxidative decomposition of an electrolyte on the surface of the positive electrode active material 100.

Accordingly, the surface portion 100a preferably has a crystal structure different from that of the inner portion 100b due to the distribution of the additive element. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charging, and is a region that tends to have a lower concentration of lithium than the inner portion 100b. It can be said that bonds between atoms are partly cut on the surface of the particle of the positive electrode active material 100 included in the surface portion 100a. Thus, the surface portion 100a is regarded as a region that tends to be unstable and tends to start deterioration of the crystal structure. Meanwhile, when the surface portion 100a can be made sufficiently stable, the layered structure, which is formed of octahedrons of cobalt and oxygen, of the inner portion 100b is unlikely to break even with small x in LiₓCoO₂, e.g., with x of 0.24 or less. Furthermore, a shift in layers, which are formed of octahedrons of cobalt and oxygen, of the inner portion 100b can be inhibited.

For example, the crystal structure preferably changes continuously from the inner portion 100b that has a layered rock-salt crystal structure toward the surface and the surface portion 100a that have a rock-salt crystal structure or have features of both a rock-salt crystal structure and a layered rock-salt crystal structure. Alternatively, the orientation of the surface portion 100a that has a rock-salt crystal structure or features of both a rock-salt crystal structure and a layered rock-salt crystal structure is preferably substantially aligned with that of the inner portion 100b that has a layered rock-salt crystal structure.

In this specification and the like, a layered rock-salt crystal structure, which belongs to the space group R-3m, of a composite oxide including lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be determined from electron diffraction, a TEM image, a cross-sectional STEM image, or the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt crystal structure and the layered rock-salt crystal structure has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal described later are presumed to form a cubic close-packed structure. Thus, when a layered rock-salt crystal and a rock-salt crystal are in contact with each other, there is a crystal plane at which orientations of cubic closest packed structures composed of anions are aligned with each other.

The description can also be made as follows. Anions on the {111}plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111}plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases. Topotaxy refers to having similarity in a three-dimensional structure such that crystal orientations are substantially aligned with each other, or to having the same orientations crystallographically.

The orientations of crystals in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, or the like. It can be determined also from an FFT pattern of a TEM image or an FFT pattern of a STEM image or the like. XRD (X-ray Diffraction), neutron diffraction, and the like can also be used for determination.

<<State where x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LiₓCoO₂ will be described with reference to FIG. 2 to FIG. 4.

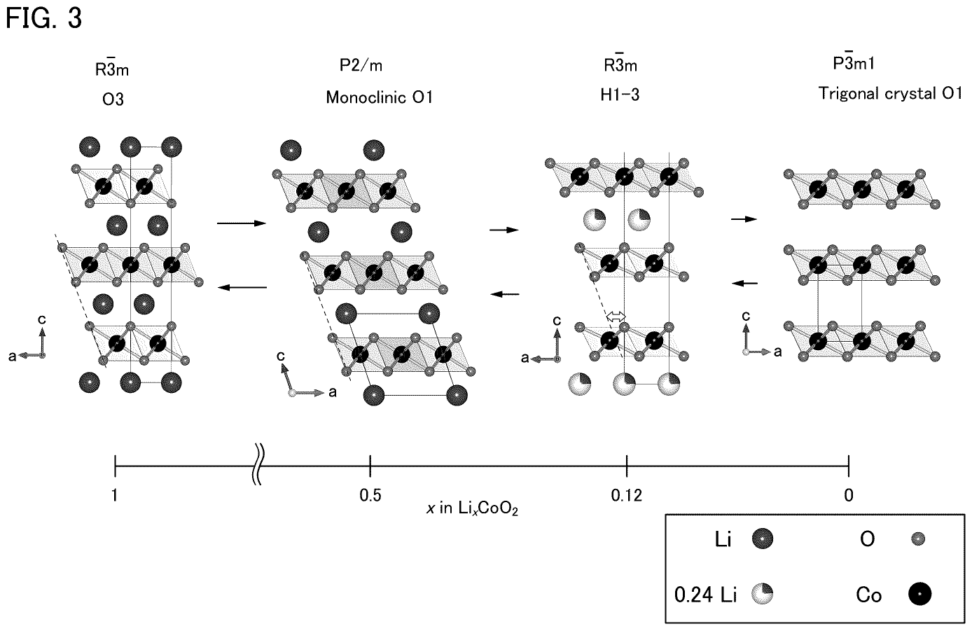

A change in the crystal structure of the conventional positive electrode active material is illustrated in FIG. 3. The conventional positive electrode active material illustrated in FIG. 3 is lithium cobalt oxide (LiCoO₂) without an additive element in particular. A change in the crystal structure of lithium cobalt oxide including no additive element is described in Non-Patent Document 1 to Non-Patent Document 3 and the like.

FIG. 3 illustrates the crystal structure of lithium cobalt oxide with x=1 in LiₓCoO₂, which is denoted by R-3m O3. In this crystal structure, lithium occupies octahedral sites and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x=0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 experimentally. The number of cobalt atoms per unit cell in the actual H1-3 type crystal structure is twice that in other structures. However, in this specification including FIG. 3, the c-axis of the H1-3 type crystal structure is half that of the unit cell for easy comparison with the other crystal structures.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrows in FIG. 3, the CoO₂ layer in the H1-3 type crystal structure largely shifts from that in R-3m O3 in a discharged state. Such a dynamic structural change can adversely affect the stability of the crystal structure.

On the other hand, in the positive electrode active material 100 of one embodiment of the present invention illustrated in FIG. 2, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 2 illustrates crystal structures of the inner portion 100b of the positive electrode active material 100 in a state where x in LiₓCoO₂ is approximately 1, in a state where x in LiₓCoO₂ is approximately 0.2, and in a state where x in LiₓCoO₂ is approximately 0.15. The inner portion 100b, accounting for the majority of the volume of the positive electrode active material 100, largely contributes to charging and discharging and is accordingly a portion where a shift in CoO₂ layers and a volume change matter most.

The positive electrode active material 100 with x=1 has the R-3m O3 type crystal structure, which is the same as that of conventional lithium cobalt oxide.

However, the positive electrode active material 100 has a crystal structure different from the H1-3 type crystal structure when x is 0.24 or less, e.g., approximately 0.2 or approximately 0.15, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 2, this crystal structure is denoted by R-3m O3′.

In the unit cell of the O3′ type crystal structure, the coordinates of cobalt and oxygen can be represented as follows: Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

When x is approximately 0.15, the positive electrode active material 100 of one embodiment of the present invention has a monoclinic crystal structure belonging to the space group P2/m. This structure includes one CoO₂ layer in a unit cell. Here, lithium in the positive electrode active material 100 is approximately 15 atomic % of that in a discharged state. Thus, this crystal structure is referred to as a monoclinic O1(15) type crystal structure. FIG. 2 illustrates this crystal structure, which is denoted by P2/m monoclinic O1(15).

In the unit cell of the monoclinic O1(15) type crystal structure, the coordinates of cobalt and oxygen can be represented by Co1 (0.5, 0, 0.5), Co2 (0, 0.5, 0.5), and O1 (X_{O1}, 0, Z_{O1}) within the ranges of 0.23≤X_{O1}≤0.24 and 0.61≤Z_{O1}≤0.65, and O2 (X_{O2}, 0.5, Z_{O2}) within the ranges of 0.75≤X_{O2}≤0.78 and 0.68≤Z_{O2}≤0.71. The unit cell has lattice constants of a=4.880±0.05 Å, b=2.817±0.05 Å, c=4.839±0.05 Å, α=90°, β=109.6±0.10, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants of a=2.817±0.02 Å and c=13.68±0.1 Å.

In both of the O3′ type crystal structure and the monoclinic O1(15) type crystal structure, an ion of cobalt, nickel, magnesium, or the like occupies a site coordinated to six oxygen atoms. Note that light elements such as lithium and magnesium sometimes occupy a site coordinated to four oxygen atoms.

As denoted by the dotted lines in FIG. 2, the CoO₂ layers hardly shift between the R-3m O3 type crystal structure in a discharged state, the O3′ type crystal structure, and the monoclinic O1(15) type crystal structure.

The R-3m O3 type crystal structure in a discharged state and the O3′ type crystal structure which include the same number of cobalt atoms have a difference in volume of 2.5% or less, specifically 2.2% or less, typically 1.8%.

The R-3m O3 type crystal structure in a discharged state and the monoclinic O1(15) type crystal structure which include the same number of cobalt atoms have a difference in volume of 3.3% or less, specifically 3.0% or less, typically 2.5%.

Table 1 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, the literature values can be referred to (ICSD coll. code. 172909 and 88721). For the lattice constants of the H1-3 type structure, Non-Patent Document 3 can be referred to. In the case of the O3′ type structure and the monoclinic O1(15) type structure, the lattice constants thereof can be calculated from the experimental values of XRD.

TABLE 1

| | | | | | Volume | Volume | Volume |
|---|---|---|---|---|---|---|---|
| Crystal | Lattice constant | | | | of unit | of one | change |
| Structure | a (Å) | b (Å) | c (Å) | β (°) | cell (Å³) | Co (Å³) | rate (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic | 4.881 | 2.817 | 4.839 | 109.6 | 62.69 | 31.35 | 2.5 |
| O1(15) | | | | | | | |
| H1-3 | 2.82 | 2.82 | 26.92 | 90 | 185.4 | 30.90 | 3.9 |
| Trigonal | 2.8048 | 2.8048 | 4.2509 | 90 | 28.96 | 28.96 | 10.0 |
| crystal O1 | | | | | | | |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume between the compared structures having the same number of cobalt atoms is inhibited. Thus, the crystal structure of the positive electrode active material 100 is less likely to break even when charging that makes x be 0.24 or less and discharging are repeated. Therefore, the positive electrode active material 100 inhibits a decrease in charge and discharge capacity in charge and discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be manufactured.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LiₓCoO₂ is greater than 0.1 and less than or equal to 0.2, typically greater than or equal to 0.17 and less than or equal to 0.15. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have only the O3′ type crystal structure, only the monoclinic O1(15) type crystal structure, or both of them. Not all particles of the inner portion 100b of the positive electrode active material 100 necessarily have the O3′ type crystal structure and/or the monoclinic O1(15) type crystal structure. The positive electrode active material may have another crystal structure or may be partly amorphous.

In order to make x in LiₓCoO₂ small, charging at a high charge voltage is necessary in general. Thus, the state where x in LiₓCoO₂ is small can be rephrased as a state where charging at a high charge voltage has been performed. For example, when CC/CV charging is performed at 25° C. and 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of lithium metal. In this specification and the like, unless otherwise specified, a charge voltage is shown with reference to the potential of lithium metal.

Thus, in other words, the positive electrode active material 100 of one embodiment of the present invention is preferable because the crystal structure with the symmetry of R-3m O3 can be maintained even when charging at a high charge voltage of 4.6 V or higher is performed at 25° C., for example. In other words, the positive electrode active material 100 of one embodiment of the present invention is preferable because the O3′ type crystal structure can be obtained when charging at a higher charge voltage, e.g., a voltage higher than or equal to 4.65 V and lower than or equal to 4.7 V is performed at 25° C. In other words, the positive electrode active material 100 of one embodiment of the present invention is preferable because the monoclinic O1(15) type crystal structure can be obtained when charging at an even higher charge voltage, e.g., a voltage higher than 4.7 V and lower than or equal to 4.8 V is performed at 25° C.

In the positive electrode active material 100, when the charge voltage is increased, the H1-3 type crystal is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C. Similarly, the positive electrode active material 100 may sometimes have the monoclinic O1(15) type crystal structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ and monoclinic O1(15) in FIG. 2, one embodiment of the present invention is not limited thereto. Lithium may exist unevenly in only some of the lithium sites; for example, lithium may symmetrically exist as in the monoclinic O1 (Li_{0.5}CoO₂) illustrated in FIG. 3. Distribution of lithium can be analyzed by neutron diffraction, for example.

The O3′ type crystal structure and the monoclinic O1(15) crystal structure can be regarded as a crystal structure that includes lithium between layers randomly but is similar to a CdCl₂ type crystal structure. The crystal structure similar to the CdCl₂ type crystal structure is close to a crystal structure of lithium nickel oxide when charged to be Li_{0.06}NiO₂; however, pure lithium cobalt oxide or a layered rock-salt positive electrode active material including a large amount of cobalt is known not to have the CdCl₂ type crystal structure in general.

### <<Crystal Grain Boundary>>

It is further preferable that the additive element included in the positive electrode active material 100 of one embodiment of the present invention have the above-described distribution and be at least partly unevenly distributed at the crystal grain boundary 101 and the vicinity thereof.

Note that in this specification and the like, uneven distribution means that the concentration of an element in a certain region differs from that in another region. This may be rephrased as segregation, deposition, unevenness, deviation, or a mixture of a high-concentration portion and a low-concentration portion.

For example, the concentration of magnesium at the crystal grain boundary 101 and the vicinity thereof in the positive electrode active material 100 is preferably higher than that in the crystal grain boundary 101 and the vicinity thereof in the inner portion 100b. In addition, the concentration of fluorine at the crystal grain boundary 101 and the vicinity thereof is preferably higher than that in the crystal grain boundary 101 and the vicinity thereof in the inner portion 100b. In addition, the concentration of nickel at the crystal grain boundary 101 and the vicinity thereof is preferably higher than that in the crystal grain boundary 101 and the vicinity thereof in the inner portion 100b. In addition, the concentration of aluminum at the crystal grain boundary 101 and the vicinity thereof is preferably higher than that in the crystal grain boundary 101 and the vicinity thereof in the inner portion 100b.

The crystal grain boundary 101 is a type of plane defect. Thus, the crystal grain boundary 101 tends to be unstable and the crystal structure easily starts to change like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with the electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 7 μm and less than or equal to 12 μm. Alternatively, it is preferably greater than or equal to 1 μm and less than or equal to 40 μm. Alternatively, it is preferably greater than or equal to 1 μm and less than or equal to 12 μm. Alternatively, it is preferably greater than or equal to 2 μm and less than or equal to 100 μm. Alternatively, it is preferably greater than or equal to 2 μm and less than or equal to 12 μm. Alternatively, it is preferably greater than or equal to 7 μm and less than or equal to 100 μm. Alternatively, it is preferably greater than or equal to 7 μm and less than or equal to 40 μm.

### <Analysis Method>

### <<Powder Resistivity Measurement>>

A method for measuring the volume resistivity in a powder of the positive electrode active material 100 of one embodiment of the present invention is described.

For measurement of the volume resistivity of the powder, an apparatus portion including terminals for resistance measurement and a mechanism for applying pressure to the powder serving as a measurement target are preferably provided. For resistance measurement, a two-terminal method is preferably used, a four-terminal method is further preferably used, and a four-probe method is still further preferably used. As such a measurement apparatus that includes the terminals for resistance measurement and the mechanism for applying pressure to the powder as a measurement target (sample), for example, MCP-PD51 manufactured by Mitsubishi Chemical Analytech Co., Ltd. can be used. As the resistance measurement apparatus, the low resistivity meter Loresta-GP or the high resistivity meter Hiresta-UP can be used. The Loresta-GP can be used for measurement of a low-resistance sample, and the Hiresta-UP can be used for measurement of a high-resistance sample. Note that the measurement environment is preferably a stable environment such as a dry room. An example of a preferable environment of the dry room is that the temperature is 25° C. and the dew point is lower than or equal to −40° C. When the measurement is performed under a high-humidity environment, the electric resistance may be lowered by the influence of moisture in the air, so that an original physical property value cannot be obtained in some cases.

The measurement of the volume resistivity of the powder using the above-described measurement apparatus is described here. First, a powder sample is set in a measurement unit. The measurement unit has a structure in which the powder sample and the terminals for resistance measurement are in contact with each other, and pressure can be applied to the powder sample. A structure for measuring the volume of a powder sample set in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of powder, the electrical resistance and volume of the powder under pressure are measured. The pressure applied to the powder can be varied. For example, the electrical resistance and volume of the powder can be measured under pressures of 16 MPa, 25 MPa, 38 MPa, 51 MPa, and 64 MPa. The volume resistivity of the powder can be calculated from the measured electrical resistance and volume of the powder.

In the case where the above-described measurement is performed and the volume resistivity in a powder of the positive electrode active material 100 of one embodiment of the present invention measured under a pressure of 64 MPa is higher than or equal to 5.0×10³ Ω·cm and lower than or equal to 1.0×10¹² Ω·cm, good cycle performance is obtained in a charge and discharge cycle test under the high voltage condition, and better cycle performance is obtained in a charge and discharge cycle test under the high voltage condition in the case where the volume resistivity is higher than or equal to 1.0×10⁷ Ω·cm and lower than or equal to 1.0×10¹⁰ Ω·cm, and much better cycle performance is obtained in a charge and discharge cycle test under the high voltage condition in the case where the volume resistivity is higher than or equal to 2.0×10⁸ Ω·cm and lower than or equal to 1.0×10¹⁰ Ω·cm

Note that in this specification and the like, unless otherwise specified, the volume resistivity measured as described above is the volume resistivity of the powder.

### <<Crystal Structure in a Charged State>>

Whether or not a given positive electrode active material is the positive electrode active material 100 of one embodiment of the present invention, which has the O3′ type crystal structure and/or monoclinic O1(15) type crystal structure when x in LiₓCoO₂ is small, can be determined by analyzing a positive electrode including the positive electrode active material with small x in LiₓCO₂ by XRD, electron diffraction, neutron diffraction, electron spin resonance (ESR), nuclear magnetic resonance (NMR), or the like.

XRD is particularly preferable because the symmetry of a transition metal M such as cobalt in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LiₓCoO₂ is 1 and when x is less than or equal to 0.24. A material 50% or more of which has the crystal structure to be largely changed by high-voltage charging is not preferable because the material cannot withstand high-voltage charging and discharging.

It should be noted that the O3′ type crystal structure or the monoclinic O1(15) type crystal structure is not obtained in some cases only by addition of the additive element. For example, when x in LiₓCoO₂ is less than or equal to 0.24, lithium cobalt oxide including magnesium and fluorine or lithium cobalt oxide including magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In addition, in the case where x is too small, e.g., 0.1 or less, or under the condition where charge voltage is higher than 4.9 V, even the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether or not the additive element included in a positive electrode active material is in the above-described state can be determined by, for example, analysis using XPS, energy dispersive X-ray spectroscopy (EDX), EPMA (Electron Probe Micro Analysis), or the like.

The crystal structure of the surface portion 100a, the crystal grain boundary 101, or the like can be analyzed by electron diffraction of a cross section of the positive electrode active material 100, for example.

Charge for determining whether or not the composite oxide is the positive electrode active material 100 having the O3′ type crystal structure and/or the monoclinic O1(15) type crystal structure when x in LiₓCoO₂ is small can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

Lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As the electrolyte solution, a solution in which 1 mol/L of lithium hexafluorophosphate (LiPF₆) is dissolved in a mixture of ethylene carbonate (EC) and diethyl carbonate (DEC) at EC:DEC=3:7 (volume ratio) and in which 2 wt % of vinylene carbonate (VC) is added as an additive agent can be used.

As a separator, a 25-μm-thick polypropylene porous film can be used.

Stainless steel (SUS) can be used for a positive electrode can and a negative electrode can.

The coin cell manufactured under the above conditions is charged with a given voltage (e.g., 4.5 V, 4.55 V, 4.6 V, 4.65 V, 4.7 V, 4.75 V, or 4.8 V). The charging method is not particularly limited as long as charging with a given voltage can be performed for sufficient time. In the case of CC/CV charging, for example, CC charging can be performed with a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charging with such a small current value is preferably performed. The temperature is set to 25° C. or 45° C. After charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. At this time, the airtight container needs to be closed tightly, and the argon atmosphere needs to be maintained during the measurement. After charging is completed, the positive electrode is preferably taken out and subjected to the analysis immediately. Specifically, the positive electrode is preferably subjected to analysis within an hour, further preferably within 30 minutes after the completion of charging. Furthermore, it takes preferably five minutes or less, further preferably two minutes or less after extraction from the glove box with an argon atmosphere before start of XRD analysis.

In the case where the crystal structure in a charged state after charging and discharging are performed multiple times is analyzed, the conditions of the charging and discharging performed multiple times may be different from the above-described charge conditions. For example, the charging can be performed by constant current charging with a current value greater than or equal to 20 mA/g and less than or equal to 100 mA/g to a given voltage (e.g., 4.6 V, 4.65 V, 4.7 V, 4.75 V, or 4.8 V) and then constant voltage charging until the current value becomes greater than or equal to 2 mA/g and less than or equal to 10 mA/g. The discharging can be performed by constant current discharging with greater than or equal to 20 mA/g and less than or equal to 100 mA/g to 2.5 V.

Also in the case where the crystal structure in a discharged state after the charging and discharging are performed multiple times is analyzed, constant current discharging can be performed at 2.5 V and a current value greater than or equal to 20 mA/g and less than or equal to 100 mA/g, for example.

### <<XRD>>

The apparatus and conditions for the XRD measurement are not particularly limited.

For example, the measurement can be performed using the following apparatus and conditions.
XRD apparatus: D8 ADVANCE manufactured by Bruker AXS, Inc.
X-ray source: Cu
Output: 40 kV, 40 mA
Angle of divergence: Div. Slit, 0.5°
Detector: LynxEye
Scanning method: 2θ/θ continuous scan
Measurement range (2θ): from 15° to 75° (100 minutes)
Step width (2θ): 0.01°
Counting time: 1 second/step
Rotation of sample stage: 15 rpm
From the obtained XRD patterns, the background and CuKa₂ radiation peak were removed using analysis software, DIFFRAC. EVA.

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

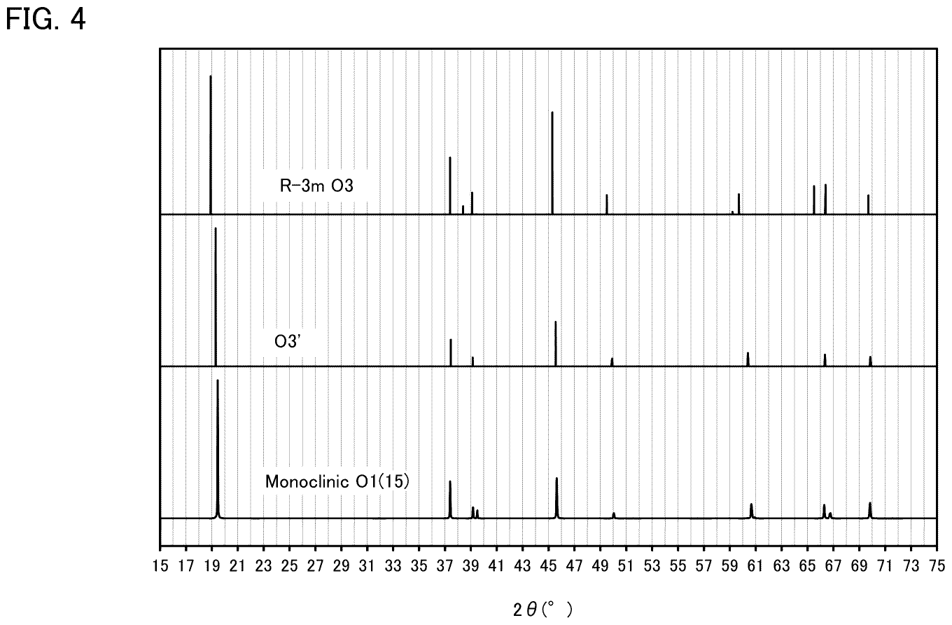

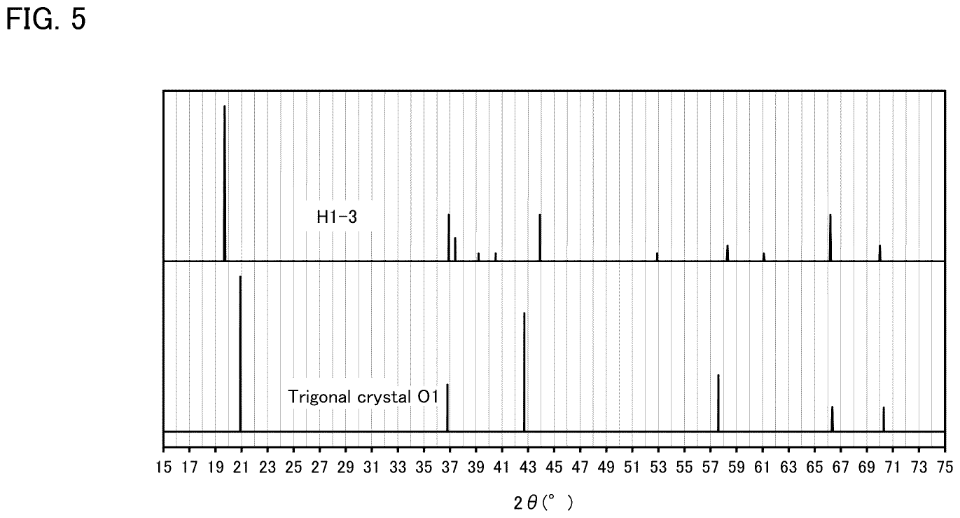

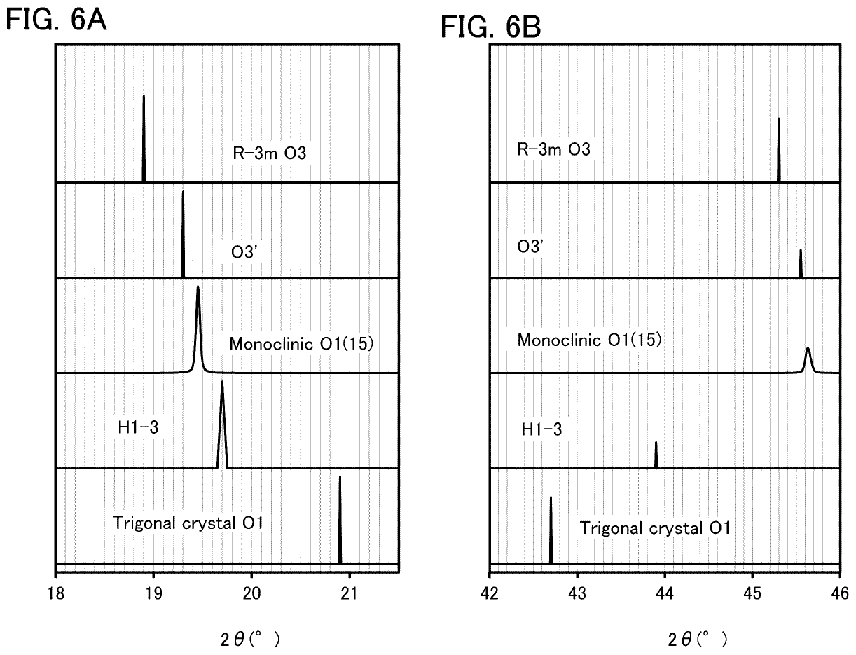

FIG. 4, FIG. 5, FIG. 6A, and FIG. 6B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of LiCoO₂ O3 with x=1 in LiₓCoO₂ and the crystal structure of the trigonal O1 with x=0 are also shown. FIG. 6A and FIG. 6B each show the XRD patterns of the O3′ type crystal structure, the monoclinic O1(15) type crystal structure, and the H1-3 type crystal structure, and FIG. 6A and FIG. 6B are enlarged diagrams showing, respectively, a range of 2θ greater than or equal to 18° and less than or equal to 21° and a range of 2θ greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 4) with Reflex Powder Diffraction, which is a module of Materials Studio (BIOVIA). The 20 range is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure and the monoclinic O1(15) type crystal structure are estimated from the XRD pattern of the positive electrode active material of one embodiment of the present invention, the crystal structure is fitted with TOPAS ver. 3 (crystal structure analysis software manufactured by Bruker Corporation), and the XRD patterns of the O3′ type crystal structure and the monoclinic O1(15) type crystal structure are made in a manner similar to that for other structures.

As shown in FIG. 4, FIG. 6A, and FIG. 6B, the O3′ type crystal structure exhibits diffraction peaks at 2θ=19.25±0.12° (greater than or equal to 19.13° and less than 19.37°) and 2θ=45.47±0.10° (greater than or equal to 45.370 and less than 45.57°).

Furthermore, the monoclinic O1(15) type crystal structure exhibits diffraction peaks at 2θ=19.47±0.10° (greater than or equal to 19.370 and less than or equal to 19.57°) and 2θ=45.62±0.05° (greater than or equal to 45.57° and less than or equal to 45.67°).

However, as shown in FIG. 5, FIG. 6A, and FIG. 6B, the H1-3 type crystal structure and the trigonal O1 do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.37° and less than 45.57° and/or greater than or equal to 45.57° and less than or equal to 45.67° in a state with small x in LiₓCoO₂ is the feature of the positive electrode active material 100 of one embodiment of the present invention.

It can also be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure and/or the monoclinic O1(15) type crystal structure when x in LiₓCoO₂ is small, not all particles necessarily have the O3′ type crystal structure and/or the monoclinic O1(15) type crystal structure. The particles may include another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can enable sufficiently good cycle performance.

Furthermore, even after 100 or more cycles of charging and discharging after the measurement starts, the O3′ type crystal structure and/or the monoclinic O1(15) type crystal structure preferably account(s) for greater than or equal to 35%, further preferably greater than or equal to 40%, still further preferably greater than or equal to 43% when the Rietveld analysis is performed.

In addition, the H1-3 type crystal structure and the O1 type crystal structure account for preferably less than or equal to 50% in the Rietveld analysis performed in a similar manner.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity contributes to stability of the crystal structure after sufficient charging.

The crystallite sizes of the O3′ type crystal structure and the monoclinic O1(15) type crystal structure included in the positive electrode active material 100 are only decreased to approximately one-twentieth that of LiCoO₂ (O3) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be, for example, the state of a powder before the manufacture of a positive electrode of a secondary battery.

Alternatively, in the layered rock-salt crystal structure of the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charging and discharging are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region that extends from the surface to a depth of approximately 2 nm to 8 nm (normally, less than or equal to 5 nm) can be analyzed by X-ray photoelectron spectroscopy (XPS) using monochromatic aluminum Ka radiation as an X-ray; thus, the concentrations of elements in a region extending to approximately half the depth of the surface portion 100a can be quantitatively analyzed by XPS. The bonding states of the elements can be analyzed by narrow scanning. Note that in many cases, the quantitative accuracy of XPS is approximately ±1 at %, and the lower detection limit is approximately 1 at % but depends on the element.

In the positive electrode active material 100 of one embodiment of the present invention, the concentration of one or two or more selected from the additive elements is preferably higher in the surface portion 100a than in the inner portion 100b. This means that the concentration of one or two or more selected from the additive elements in the surface portion 100a is preferably higher than the average concentration of the selected element(s) in the entire positive electrode active material 100. For this reason, for example, it is preferable that the concentration of one or two or more additive elements selected from the surface portion 100a, which is measured by XPS or the like, be higher than the average concentration of the additive element(s) in the entire positive electrode active material 100, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the average concentration of magnesium in the entire positive electrode active material 100. The concentration of nickel in at least part of the surface portion 100a is preferably higher than the average concentration of nickel in the entire positive electrode active material 100. The concentration of aluminum in at least part of the surface portion 100a is preferably higher than the average concentration of aluminum in the entire positive electrode active material 100. The concentration of fluorine in at least part of the surface portion 100a is preferably higher than the average concentration of fluorine in the entire positive electrode active material 100.

Note that the surface and the surface portion 100a of the positive electrode active material 100 of one embodiment of the present invention do not include a carbonate, a hydroxy group, or the like which is chemically adsorbed after manufacture of the positive electrode active material 100. Furthermore, an electrolyte solution, a binder, a conductive material, and a compound originating from any of these that are attached to the surface of the positive electrode active material 100 are not included either. Thus, in quantitative analysis of the elements included in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

For example, in the XPS analysis, the atomic ratio of magnesium to cobalt (Mg/Co) is preferably greater than or equal to 0.4 and less than or equal to 1.5. In the ICP-MS analysis, (Mg/Co) is preferably greater than or equal to 0.002 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or two or more selected from the additive elements included in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher than the concentration of fluorine.

It is further preferable that the additive element Y such as aluminum be widely distributed in a deep region, e.g., a region ranging from a depth from the surface of 5 nm or more to a depth from the surface of 50 nm or less. Thus, the additive element Y such as aluminum is detected by analysis on the entire positive electrode active material 100 by ICP-MS, GD-MS, or the like, but the concentration of the additive element Y such as aluminum is preferably lower than or equal to the lower detection limit in XPS or the like.

Furthermore, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quantera II manufactured by PHI, Inc.
X-ray source: monochromatic Al Kα (1486.6 eV)
Detection area: 100 μmφ
Detection depth: approximately 4 to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

The one or two or more selected from the additive elements included in the positive electrode active material 100 preferably have a concentration gradient. It is further preferable that the additive elements included in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferable because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of each additive element, in particular, the additive element Xin the surface portion 100a is higher than that in the inner portion 100b.

The surface of the positive electrode active material in, for example, STEM-EDX line analysis refers to a point where the value of characteristic X-rays derived from cobalt is equal to 50% of the sum of the average value M_{AVE} of the amount of detected cobalt in the inner portion and the average value M_{BG} of the amount of background cobalt and a point where the value of characteristic X-rays derived from oxygen is equal to 50% of the sum of the average value O_{AVE} of the amount of detected oxygen in the inner portion and the average value O_{BG} of the amount of background oxygen. Note that in the case where the positions of the points differ between cobalt and oxygen, the difference is probably due to the influence of a carbonate, a metal oxide including oxygen, or the like, which is attached to the surface. Thus, the point that is equal to 50% of the sum of the average value M_{AVE} of the amount of detected cobalt in the inner portion and the average value MG of the amount of background cobalt can be used.

The average value M_{BG} of the amount of background cobalt can be calculated by averaging the amounts of detected cobalt in the range greater than or equal to 2 nm, preferably greater than or equal to 3 nm, which is outside a portion of the positive electrode active material in the vicinity of the portion at which the amount of detected cobalt begins to increase, for example. The average value M_{AVE} of the amount of detected cobalt in the inner portion can be calculated by averaging the amounts of detected cobalt in the range greater than or equal to 2 nm, preferably greater than or equal to 3 nm in a region where the count numbers of cobalt and oxygen atoms are saturated and stabilized, e.g., a portion that is greater than or equal to 30 nm, preferably greater than 50 nm in depth from the portion where the amount of detected cobalt begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface toward the bulk and an axis in the depth direction in a STEM image. The surface in a STEM image or the like may be judged in combination with analysis with higher spatial resolution.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

For example, EDX area analysis or EDX point analysis of the positive electrode active material 100 including magnesium as the additive element preferably reveals that the concentration of magnesium in the surface portion 100a is higher than that in the inner portion 100b. In the EDX line analysis, a peak of the concentration of magnesium in the surface portion 100a exists at a depth of preferably 3 nm or less, further preferably 1 nm or less, still further preferably 0.5 nm or less from the surface of the positive electrode active material 100 toward the center. Alternatively, the depth is preferably within ±1 nm from the surface. In addition, the magnesium concentration preferably attenuates, at a depth of 1 nm from the peak position, to less than or equal to 60% of the peak concentration. In addition, the magnesium concentration preferably attenuates, at a depth of 2 nm from the peak position, to less than or equal to 30% of the peak concentration. Here, “peak concentration” (also referred to “peak top”) refers to the local maximum value of the concentration. Note that due to the influence of spatial resolution in the EDX line analysis, the position where the peak of the magnesium concentration exists sometimes has a negative value as a depth from the surface toward the inner portion.

When the positive electrode active material 100 includes magnesium and fluorine as the additive elements, the distribution of fluorine preferably overlaps with the distribution of magnesium. For example, a difference in the depth direction between the peak concentration of fluorine and the peak concentration of magnesium is preferably within 10 nm, further preferably within 3 nm, still further preferably within 1 nm.

In the EDX line analysis, the peak concentration of fluorine in the surface portion 100a preferably exists at a depth of preferably 3 nm or less, further preferably 1 nm or less, still further preferably 0.5 nm or less from the surface of the positive electrode active material 100 toward the center. Alternatively, the depth is preferably within ±1 nm from the surface. It is further preferable that the peak concentration of fluorine be exhibited slightly closer to the surface than the peak concentration of magnesium is, which increases resistance to hydrofluoric acid. For example, it is preferable that the peak concentration of fluorine be exhibited slightly closer to the surface than the peak concentration of magnesium is by 0.5 nm or more, further preferably 1.5 nm or more.

In the positive electrode active material 100 including nickel as the additive element, the peak concentration of nickel in the surface portion 100a preferably exists at a depth of preferably 3 nm or less, further preferably 1 nm or less, still further preferably 0.5 nm or less from the surface of the positive electrode active material 100 toward the center. Alternatively, the depth is preferably within ±1 nm from the surface. When the positive electrode active material 100 includes magnesium and nickel, the distribution of nickel preferably overlaps with the distribution of magnesium. For example, a difference in the depth direction between the peak concentration of nickel and the peak concentration of magnesium is preferably within 10 nm, further preferably within 3 nm, still further preferably within 1 nm.

In the case where the positive electrode active material 100 includes aluminum as the additive element, the peak concentration of magnesium, nickel, or fluorine is preferably closer to the surface than the peak concentration of aluminum is in the surface portion 100a in the EDX line analysis. For example, a peak of the aluminum concentration preferably exists in a region from the surface of the positive electrode active material 100 to a depth greater than or equal to 0.5 nm and less than or equal to 50 nm, further preferably to a depth greater than or equal to 3 nm and less than or equal to 30 nm toward the center.

When aluminum enters deeply from the basal region to the inner portion side of the positive electrode active material 100, the concentration of aluminum in the surface portion 100a is reduced, so that a change in the crystal structure due to charging and discharging is less likely to be inhibited. Thus, the concentration of aluminum in the basal region preferably attenuates, at a depth of less than or equal to 25 nm from the surface, to less than or equal to 50% of the peak.

When EDX line, area, or point analysis is performed on the positive electrode active material 100, the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the concentration of nickel is preferably greater than or equal to 0 and less than or equal to 0.2, further preferably greater than or equal to 0.01 and less than or equal to 0.1. The atomic ratio of fluorine F to cobalt Co (F/Co) at a peak of the concentration of fluorine is preferably greater than or equal to 0 and less than or equal to 1.6, further preferably greater than or equal to 0.1 and less than or equal to 1.4.

The crystal grain boundary 101 refers to, for example, a portion where particles of the positive electrode active material 100 adhere to each other or a portion where a crystal orientation changes inside the positive electrode active material 100, e.g., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure including another atom between lattices, a hollow, or the like. The crystal grain boundary 101 can be regarded as one of plane defects. The vicinity of the crystal grain boundary 101 refers to a region to less than or equal to 10 nm from the crystal grain boundary 101.

When the line analysis or the area analysis is performed on the positive electrode active material 100, the atomic ratio of the additive element A to cobalt Co (A/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 including magnesium as the additive element, the atomic ratio of magnesium to cobalt (Mg/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal To 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<Particle Size Distribution Measurement>>

Particle size distribution measurement of the powder of the positive electrode active material 100 of one embodiment of the present invention can be measured with a particle size distribution measurement apparatus or the like using a laser diffraction and scattering method. When measured using a laser diffraction and scattering method, particle size distribution based on volume can be obtained. As the particle size distribution measurement apparatus, a laser diffraction particle size distribution measurement apparatus SALD-2200 manufactured by Shimadzu Corporation, for example, can be used.

Note that particle size distribution refers to particle size distribution of a powder unless otherwise specified in the present specification and the like.

A median diameter refers to a particle diameter at a cumulative value of 50% in a cumulative distribution curve obtained by particle size distribution measurement. The median diameter is also referred to as D50 or a 50% particle diameter.

A 10% particle diameter refers to a particle diameter at a cumulative value of 10% in a cumulative distribution curve obtained by particle size distribution measurement. The 10% particle diameter is also referred to as D10. A 90% particle diameter refers to a particle diameter at a cumulative value of 90% in a cumulative distribution curve obtained by particle size distribution measurement. The 90% particle diameter is also referred to as D90.

Note that in this specification, unless otherwise specified, particle size distribution of a positive electrode active material is particle size distribution based on volume. The value of the particle diameter obtained from the particle size distribution is the value of the particle diameter obtained from the particle size distribution based on volume.

In the case where the above-described particle size distribution measurement is performed and the powder of the positive electrode active material 100 of one embodiment of the present invention has a median diameter (D50) of greater than or equal to 7 μm and less than or equal to 12 μm, the positive electrode active material 100 exhibits preferable cycle performance in a charge and discharge cycle test under a high voltage condition.

A smaller particle diameter of the positive electrode active material 100 is preferable because it improves rate characteristics and/or charge and discharge characteristics at low temperatures. When the particle diameter is small, i.e., the specific surface area is large, however, an excessive reaction with the electrolyte solution might be large. Thus, it is preferable that the additive elements be distributed at a preferable concentration in the surface portion as described above to increase the volume resistivity in a powder. As a result, both improved rate characteristics and/or improved charge and discharge characteristics at low temperatures and suppressed overreaction with the electrolyte solution can be achieved.

### <<Current-Rest-Method>>

The distribution of the additive element included in the surface portion of the positive electrode active material 100 of one embodiment of the present invention, such as magnesium, sometimes slightly changes during repeated charging and discharging. For example, in some cases, the distribution of the additive element becomes more favorable, so that the electronic conduction resistance decreases. Thus, in some cases, the electrical resistance, i.e., a resistance component R (0.1 s) with a high response speed measured by a current-rest-method, decreases at the initial stage of the charge and discharge cycles.

For example, when the n-th (n is a natural number greater than 1) charging and the n+1-th charging are compared, the resistance component R(0.1 s) with a high response speed measured by a current-rest-method is lower in the n+1-th charging than in the n-th charging in some cases. Accordingly, the n+1-th discharge capacity is higher than the n-th discharge capacity in some cases. Also in the case of a positive electrode active material that does not include any additive element, the second charge capacity can be higher than the initial charge capacity, i.e., n=1; thus, n is preferably greater than or equal to 2 and less than or equal to 10, for example. However, n is not limited to the above for the initial stage of the charge and discharge cycles. The stage where the charge and discharge capacity is substantially the same as the rated capacity or is greater than or equal to 97% of the rated capacity can be regarded as the initial stage of the charge and discharge cycles.

### <<Nanobeam Electron Diffraction Pattern>>

Features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be secured and a function of stabilizing a crystal structure can be enhanced in the case where the additive element such as magnesium is present in the lithium layer while the outermost surface has a layered rock-salt crystal structure as compared with the case where the outermost surface is covered with a rock-salt crystal structure.

Therefore, for example, when a nanobeam electron diffraction pattern of a region from the surface to a depth of 1 nm or less and a nanobeam electron diffraction pattern of a region that extends from a depth from the surface of 3 nm to a depth from the surface of 10 nm are obtained, a difference between lattice constants calculated from the patterns is preferably small.

For example, a difference between lattice constants calculated from a measured portion from the surface to a depth of 1 nm or less and a measured portion ranging from a depth from the surface of 3 nm or more to a depth from the surface of 10 nm or less is preferably less than or equal to 0.1 Å for the a-axis and less than or equal to 1.0 Å for the c-axis. The difference is further preferably less than or equal to 0.03 Å for the a-axis and further preferably less than or equal to 0.6 Å for the c-axis. The difference is still further preferably less than or equal to 0.04 Å for the a-axis and still further preferably less than or equal to 0.3 Å for the c-axis.

### <Additional Features>

The positive electrode active material 100 has a depression, a crack, a concave, a V-shaped cross section, or the like in some cases. These are examples of defects, and when charging and discharging are repeated, dissolution of cobalt, breakage of a crystal structure, cracking of the positive electrode active material 100, extraction of oxygen, or the like might be derived from these defects. However, when there is the filling portion 102 illustrated in FIG. 1B that fills such defects, dissolution of cobalt or the like can be inhibited. Thus, the positive electrode active material 100 can have high reliability and enables excellent cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be included in the positive electrode active material 100 at an appropriate concentration; however, the adjustment of the concentration is not easy.

For this reason, in the positive electrode active material 100, when the region 103 where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when a secondary battery is manufactured. A feature of inhibiting an internal resistance increase in a secondary battery is extremely preferable especially in charge and discharge with a large amount of current such as charge and discharge at 400 mA/g or more.

In the positive electrode active material 100 including the region 103 where the additive element is unevenly distributed, mixing of excess additive elements to some extent in the formation process is acceptable. This is preferable because the margin of production can be increased.

This embodiment can be used in combination with the other embodiments.

### Embodiment 2

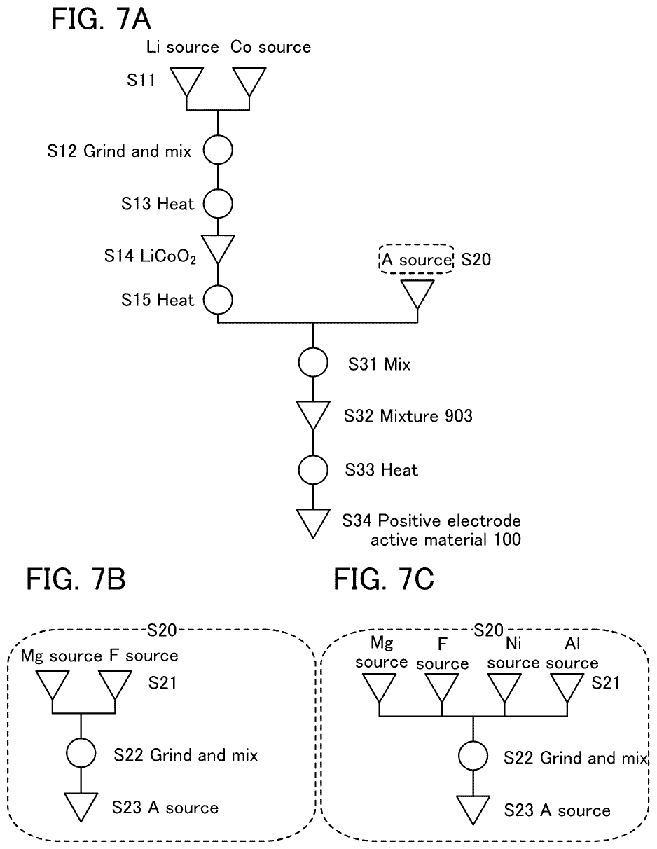

In this embodiment, an example of a method for manufacturing the positive electrode active material 100 of one embodiment of the present invention is described. FIG. 7A to FIG. 9C are diagrams illustrating methods for manufacturing the positive electrode active material 100.

A way of adding the additive element is important in manufacturing the positive electrode active material 100 having the distribution of the additive element, the composition, and/or the crystal structure described in the above embodiment. Favorable crystallinity of the inner portion 100b is important as well.

Thus, in the formation process of the positive electrode active material 100, preferably, lithium cobalt oxide is synthesized first, then an additive element source is mixed, and heat treatment is performed.

In a method of synthesizing lithium cobalt oxide including an additive element by mixing an additive element source concurrently with a cobalt source and a lithium source, it is difficult to increase the concentration of the additive element in the surface portion 100a. In addition, after lithium cobalt oxide is synthesized, only mixing an additive element source without performing heating causes the additive element to be just attached to the lithium cobalt oxide without forming a solid solution therewith. It is difficult to distribute the additive element favorably without sufficient heating. Therefore, it is preferable that lithium cobalt oxide be synthesized, and then an additive element source be mixed and heat treatment be performed. The heat treatment after mixing of the additive element source is sometimes referred to as annealing.

However, annealing at an excessively high temperature may cause cation mixing, which increases the possibility of entry of the additive element such as magnesium into cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

When the annealing temperature is too high, the lithium cobalt oxide particles are sintered. When the specific surface area of LiₓCoO₂ is reduced by the sintering and the reduced specific surface area of LiₓCoO₂ becomes a barrier against extraction of lithium ions from the particle surface, the capacity of the battery might be reduced.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. The decrease in the melting points makes it easier to favorably distribute the additive element at a temperature at which the cation mixing is unlikely to occur.

### [Initial Heating]

It is further preferable that heating be performed after the synthesis of the lithium cobalt oxide and before the mixing of the additive element. This heating is referred to as initial heating in some cases.

Since a lithium compound or the like unintentionally remaining on a surface of lithium cobalt oxide is extracted by the initial heating, the distribution of the additive element becomes more favorable.

Specifically, the distributions of the additive elements can be easily made different from each other by the initial heating in the following mechanism. First, by the initial heating, a lithium compound or the like unintentionally remaining on a surface of lithium cobalt oxide is extracted. Next, the additive element sources such as a nickel source, an aluminum source, and a magnesium source and the lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase including Co²⁺, which is reduced due to lithium deficiency, Mg²⁺, and Ni²⁺ is formed. Note that this phase is formed in part of the surface portion 100a, and thus is sometimes not clearly observed in an electron microscope image, such as a STEM image, and an electron diffraction pattern.

Among the additive elements, nickel is likely to form a solid solution and is diffused to the inner portion 100b in the case where the surface portion 100a is the lithium cobalt oxide that has a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, the Me-O distance is 2.09 Å and 2.11 Å in Ni_{0.5}Mg_{0.5}O having a rock-salt crystal structure and MgO having a rock-salt crystal structure, respectively. Even when a spinel phase is formed in part of the surface portion 100a, the Me-O distance in NiAl₂O₄ having a spinel structure is 2.0125 Å and the Me-O distance in MgAl₂O₄ having a spinel structure 2.02 Å is. In each case, the Me-O distance is longer than 2 Å. Note that 1 Å=10⁻¹⁰ m.

By contrast, in a layered rock-salt crystal structure, the bond distance between oxygen and a metal other than lithium is shorter than the above-described distance. For example, the Al—O distance is 1.905 Å (the Li—O distance is 2.11 Å) in LiAlO₂ having a layered rock-salt crystal structure. In addition, the Co—O distance is 1.9224 Å (the Li—O distance is 2.0916 Å) in LiCoO₂ having a layered rock-salt crystal structure.

According to Shannon's ionic radii (Non-Patent Document 6), the ion radius of hexacoordinated aluminum and the ion radius of hexacoordinated oxygen are 0.535 Å and 1.4 Å, respectively, and the sum of those values is 1.935 Å.

From the above, aluminum can be considered to exist at sites other than lithium sites more stably in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface.

Moreover, the initial heating can be expected to have an effect of increasing the crystallinity of the layered rock-salt crystal structure of the inner portion 100b.

For this reason, the initial heating is preferably performed in order to manufacture the positive electrode active material 100 that has the monoclinic O1(15) type crystal structure particularly when x in LiₓCoO₂ is, for example, greater than or equal to 0.15 and less than or equal to 0.17.

However, the initial heating is not necessarily performed. In some cases, by controlling the atmosphere, temperature, time, or the like in another heating step, e.g., annealing, the positive electrode active material 100 that has the O3′ type structure and/or the monoclinic O1(15) type structure when x in LiₓCoO₂ is small can be manufactured.

### <<Manufacture Method 1 of Positive Electrode Active Material>>

A manufacture method 1 of the positive electrode active material 100, in which annealing and the initial heating are performed, is described with reference to FIG. 7A to FIG. 7C.

### <Step S11>

In Step S11 illustrated in FIG. 7A, a lithium source (Li source) and a cobalt source (Co source) are prepared as materials for lithium and a transition metal M which are starting materials.

As the lithium source, a lithium-including compound is preferably used, and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-including compound is preferably used, and for example, tricobalt tetraoxide, cobalt hydroxide, or the like can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity, and preferably includes single crystal particles, for example. The crystallinity of the cobalt source can be evaluated with a TEM (transmission electron microscope) image, a STEM (scanning transmission electron microscope) image, a HAADF-STEM (high-angle annular dark-field scanning transmission electron microscope) image, or an ABF-STEM (annular bright-field scanning transmission electron microscope) image or by X-ray diffraction (XRD), electron diffraction, neutron diffraction, or the like. Note that the above methods for evaluating crystallinity can also be employed to evaluate the crystallinity of other materials in addition to the cobalt source.

### <Step S12>

Next, in Step S12 illustrated in FIG. 7A, the lithium source and the cobalt source are ground and mixed to manufacture a mixed material. The grinding and mixing can be performed by a dry method or a wet method. A wet method enables finer grinding and mixing of particles. When a wet method is employed, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With the use of dehydrated acetone with the above-described purity, impurities that might be mixed can be reduced.

A ball mill, a bead mill, or the like can be used as a means of the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 illustrated in FIG. 7A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-including atmosphere. In a method, a dry air is continuously introduced into a reaction chamber. The flow rate of a dry air in this case is preferably 10 L/min. A method of continuously introducing oxygen into a reaction chamber to make oxygen flow therein is referred to as flowing.

In the case where the heating atmosphere is an oxygen-including atmosphere, flowing is not necessarily performed. For example, a method may be employed in which the pressure in the reaction chamber is reduced, the reaction chamber is filled (which may also be referred to as purged) with oxygen, and the oxygen is prevented from entering or exiting from the reaction chamber. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

This heating step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization of a material.

A used crucible is preferred to a new crucible. In this specification and the like, a new crucible refers to a crucible that is subjected to heating two or less times while a material including lithium, the transition metal M, and/or the additive element is included therein. A used crucible refers to a crucible that is subjected to heating three or more times while a material including lithium, the transition metal M, and/or the additive element is included therein. The reason is that, in the case where a new crucible is used, some materials such as lithium fluoride might be absorbed by, diffused in, transferred to, and/or attached to the crucible. Loss of some materials due to such phenomena increases a concern that an element is not distributed in a preferable range particularly in the surface portion of the positive electrode active material. In contrast, such a risk is low in the case of a used crucible.

The heated material is crushed as needed and may be made to pass through a sieve. Before collection of the heated material, the material may be moved from the crucible to a mortar. As the mortar, a zirconium oxide mortar can be suitably used. A zirconium oxide mortar has a material property that hardly releases impurities. Specifically, a mortar made of zirconium oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 7A.

Although the example is described in which the composite oxide is manufactured by a solid phase method as in Step S11 to Step S14, the composite oxide may be manufactured by a coprecipitation method. Alternatively, the composite oxide may be manufactured by a hydrothermal method.

### <Step S15>

Next, as Step S15 illustrated in FIG. 7A, the lithium cobalt oxide is heated. The heating in Step S15 is the first heating performed on the lithium cobalt oxide and thus is sometimes referred to as initial heating. The heating is performed before Step S33 described below and thus is sometimes referred to as preheating or pretreatment.

By the initial heating, lithium is extracted from part of the surface portion 100a of the lithium cobalt oxide as described above. In addition, an effect of increasing the crystallinity of the inner portion 100b can be expected. The lithium source and/or the cobalt source prepared in Step S11 and the like might include impurities. The initial heating can reduce impurities in the lithium cobalt oxide completed in Step S14.

Through the initial heating, an effect of smoothing the surface of the lithium cobalt oxide is obtained. A smooth surface refers to a state where the composite oxide has little unevenness and is rounded as a whole and its corner portion is rounded. Being smooth also refers to a state where few foreign substances are attached to the surface. Foreign substances are deemed to cause unevenness and are preferably not attached to a surface.

For the initial heating, there is no need to prepare the lithium source. Alternatively, there is no need to prepare the additive element source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected to perform the heating. As a supplementary explanation of the heating conditions, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the lithium cobalt oxide manufactured in Step S13.

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charging and discharging is inhibited and a crack in the positive electrode active material can be prevented.

Note that pre-synthesized lithium cobalt oxide may be used in Step S14. In that case, Step S11 to Step S13 can be omitted. When Step S15 is performed on the pre-synthesized lithium cobalt oxide, lithium cobalt oxide with a smooth surface can be obtained.

### <Step S20>

Next, as illustrated in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIG. 7B and FIG. 7C.

### <Step S21>

In Step S21 illustrated in FIG. 7B, an additive element A source (A source) to be added to the lithium cobalt oxide is prepared. A lithium source may be prepared together with the additive element A source.

As the additive element A, the additive element described in the above embodiment, such as the additive element X or the additive element Y, can be used. Specifically, one or two or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or two selected from bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

As the fluorine source, for example, lithium fluoride (LiF), magnesium fluoride (MgF₂), aluminum fluoride (ALF₃), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used also as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or the neighborhood thereof). Note that in this specification and the like, the neighborhood means a value greater than 0.9 times and less than 1.1 times a given value.

### <Step S22>

Next, in Step S22 illustrated in FIG. 7B, the magnesium source and the fluorine source are ground and mixed. Any of the conditions for the grinding and the mixing that are described for Step S12 can be selected to perform this step.

### <Step S23>

Next, in Step S23 illustrated in FIG. 7B, the materials ground and mixed in the above step are collected to give the additive element A source (A source). Note that the additive element A source illustrated in Step S23 includes a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may include only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion 100a of the composite oxide after heating.

### <Step S21>

A process different from that in FIG. 7B is described with reference to FIG. 7C. In Step S21 illustrated in FIG. 7C, four kinds of additive element sources to be added to the lithium cobalt oxide are prepared. In other words, FIG. 7C is different from FIG. 7B in the kinds of the additive element sources. A lithium source may be prepared together with the additive element sources.

As the four kinds of additive element sources, a magnesium source (Mg source), a fluorine source (F source), a nickel source (Ni source), and an aluminum source (A1 source) are prepared. Note that the magnesium source and the fluorine source can be selected from the compounds and the like described with reference to FIG. 7B. As the nickel source, nickel oxide, nickel hydroxide, or the like can be used. As the aluminum source, aluminum oxide, aluminum hydroxide, or the like can be used.

### <Step S22 and Step S23>

Step S22 and Step S23 illustrated in FIG. 7C are similar to the steps described with reference to FIG. 7B.

### <Step S31>

Next, in Step S31 illustrated in FIG. 7A, the lithium cobalt oxide and the additive element A source (A source) are mixed.

In this embodiment, the number of magnesium atoms included in the additive element A source is preferably greater than or equal to 0.50% and less than or equal to 3.0%, further preferably greater than or equal to 0.75% and less than or equal to 2.0%, still further preferably greater than or equal to 0.75% and less than or equal to 1.0% with respect to the number of cobalt atoms included in the lithium cobalt oxide.

The conditions of the mixing in Step S31 are preferably milder than those of the mixing in Step S12 in order not to damage the shape of the lithium cobalt oxide particles. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 7A, the materials mixed in the above step are collected to give a mixture 903. At the time of the collection, the materials may be made to pass through a sieve as needed.

Note that although FIG. 7A to FIG. 7C illustrate the manufacture method in which addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide including the additive element can be obtained in Step S13. In this case, there is no need to separately perform Step S11 to Step S14 and Step S21 to Step S23. This method can be regarded as being simple and highly productive.

Alternatively, lithium cobalt oxide that includes some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed on lithium cobalt oxide to which magnesium and fluorine are added in advance, a magnesium source and a fluorine source, or a magnesium source, a fluorine source, a nickel source, and an aluminum source may be further added as in Step S20 to Step S31.

### <Step S33>

Then, in Step S33 illustrated in FIG. 7A, the mixture 903 is heated. Any of the heating conditions described for Step S13 can be selected to perform the heating. The heating time is preferably longer than or equal to 2 hours.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature T_{d}). Accordingly, the heating temperature in Step S33 is higher than or equal to 650° C.

Needless to say, the reaction more easily proceeds at a temperature higher than or equal to the temperature at which one or two or more selected from the materials included in the mixture 903 are melted. For example, in the case where LiF and MgF₂ are included in the additive element source, the lower limit of the heating temperature in Step S33 is preferably higher than or equal to 742° C. because the eutectic point of LiF and MgF₂ is around 742° C.

The mixture 903 obtained by mixing at LiCoO₂:LiF:MgF₂=100:0.33:1 (molar ratio) exhibits an endothermic peak at around 830° C. in differential scanning calorimetry measurement (DSC measurement). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride originating from the fluorine source or the like is preferably controlled to be within an appropriate range.

In the manufacture method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and manufacture of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiCoO₂ and F of the fluorine source might react to manufacture LiF, which might be volatilized. Thus, such inhibition of volatilization is needed also when a fluoride having a higher melting point than LiF is used.

In view of this, the mixture 903 is preferably heated in an atmosphere including LiF, i.e., the mixture 903 is preferably heated in a state where the partial pressure of LiF in a heating furnace is high. Such heating can inhibit volatilization of LiF in the mixture 903.

This heating step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-including atmosphere in the kiln is controlled. For example, the flow rate of an oxygen-including atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere including LiF with the container including the mixture 903 covered with a lid, for example.

A supplementary explanation of the heating time is given here. The heating time depends on conditions such as the heating temperature and the size and composition of the lithium cobalt oxide in Step S14. In the case where the lithium cobalt oxide is small, the heating is preferably performed at a lower temperature or for a shorter time than in the case where the lithium cobalt oxide is large, in some cases.

In the case where the lithium cobalt oxide in Step S14 in FIG. 7A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

Next, the heated material is collected in Step S34 illustrated in FIG. 7A to give the positive electrode active material 100. At this time, the collected particles can be crushed by being made to pass through a sieve as needed. Through the above process, the positive electrode active material 100 of one embodiment of the present invention can be formed. The positive electrode active material of one embodiment of the present invention has a smooth surface.

### <<Manufacture Method 2 of Positive Electrode Active Material>>

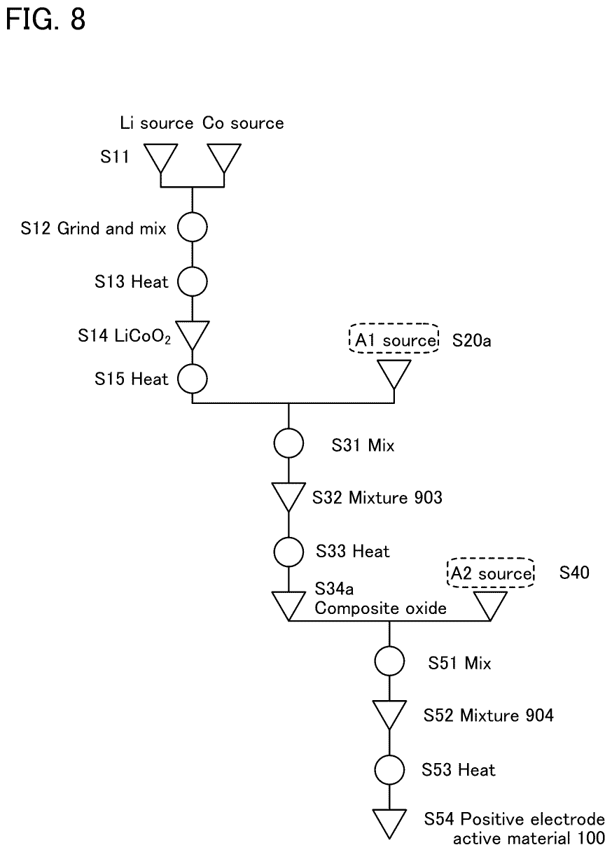

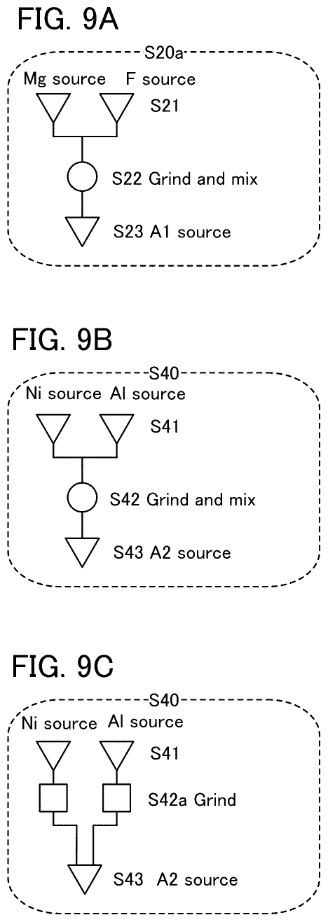

Next, as one embodiment of the present invention, a manufacture method 2 of a positive electrode active material, which is different from the manufacture method 1 of a positive electrode active material, will be described with reference to FIG. 8 to FIG. 9C. The manufacture method 2 of a positive electrode active material is different from the manufacture method 1 mainly in the number of times of adding additive elements and a mixing method. For the description except for the above, the description of the manufacture method 1 can be referred to.

Steps S11 to S15 in FIG. 8 are performed as in FIG. 7A to prepare lithium cobalt oxide that has been subjected to the initial heating.

### <Step S20a>

Next, as illustrated in Step S20a, an additive element A1 is preferably added to the lithium cobalt oxide that has been subjected to the initial heating.

### <Step S21>

In Step S21 illustrated in FIG. 9A, a first additive element source is prepared. The first additive element source can be selected from the additive elements A described for Step S21 with reference to FIG. 7B to be used. For example, one or more selected from magnesium, fluorine, and calcium can be suitably used as the additive element A1. FIG. 9A illustrates an example of using a magnesium source (Mg source) and a fluorine source (F source) as the first additive element source.

Step S21 to Step S23 illustrated in FIG. 9A can be performed under the conditions similar to those in Step S21 to Step S23 illustrated in FIG. 7B. As a result, the additive element source (A1 source) can be obtained in Step S23.

Steps S31 to S33 illustrated in FIG. 8 can be performed in a manner similar to that of Steps S31 to S33 illustrated in FIG. 7A.

### <Step S34a>

Next, the material heated in Step S33 is collected to manufacture lithium cobalt oxide including the additive element A1. This composite oxide is also called a second composite oxide to be distinguished from the composite oxide in Step S14.

### <Step S40>

In Step S40 illustrated in FIG. 8, an additive element A2 is added. FIG. 9B and FIG. 9C are referred to in the following description.

### <Step S41>

In Step S41 illustrated in FIG. 9B, a second additive element source is prepared. The second additive element source can be selected from the additive elements A described for Step S21 with reference to FIG. 7B to be used. For example, one or more selected from nickel, boron, zirconium, and aluminum can be suitably used as the additive element A2. FIG. 9B illustrates an example of using a nickel source (Ni source) and an aluminum source (A1 source) as the second additive element source.

Step S41 to Step S43 illustrated in FIG. 9B can be performed under the conditions similar to those in Step S21 to Step S23 illustrated in FIG. 7B. As a result, the additive element source (A2 source) can be obtained in Step S43.

FIG. 9C illustrates a modification example of the steps described with reference to FIG. 9B. A nickel source (Ni source) and an aluminum source (A1 source) are prepared in Step S41 illustrated in FIG. 9C and are separately ground in Step S42a. Accordingly, a plurality of the second additive element sources (A2 sources) are prepared in Step S43. The step in FIG. 9C is different from the step in FIG. 9B in separately grinding the additive elements in Step S42a.

### <Step S51 to Step S53>

Next, Step S51 to Step S53 illustrated in FIG. 8 can be performed under the conditions similar to those in Step S31 to Step S34 illustrated in FIG. 7A. The heating in Step S53 can be performed at a lower temperature and for a shorter time than the heating in Step S33. Through the above steps, the positive electrode active material 100 of one embodiment of the present invention can be formed in Step S54. The positive electrode active material of one embodiment of the present invention has a smooth surface.

As illustrated in FIG. 8 and FIG. 9, in the manufacture method 2, introduction of the additive element to the lithium cobalt oxide is divided into introduction of the additive element A1 and that of the additive element A2. When the elements are separately introduced, the additive elements can be differently distributed in the depth direction. For example, the additive element A1 can be distributed such that its concentration is higher in the surface portion than in the inner portion, and the additive element A2 can be distributed such that its concentration is higher in the inner portion than in the surface portion.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. The steps are preferably performed in such an order to maintain the smoothness of the surface achieved by the initial heating.

This embodiment can be used in combination with the other embodiments.

### Embodiment 3

In this embodiment, components included in a lithium-ion battery are described.

### [Positive Electrode]

A positive electrode includes a positive electrode active material layer and a positive electrode current collector. The positive electrode active material layer includes a positive electrode active material and may further include at least one of a conductive material and a binder. As the positive electrode active material, any of the positive electrode active materials described in Embodiment 1 can be used.

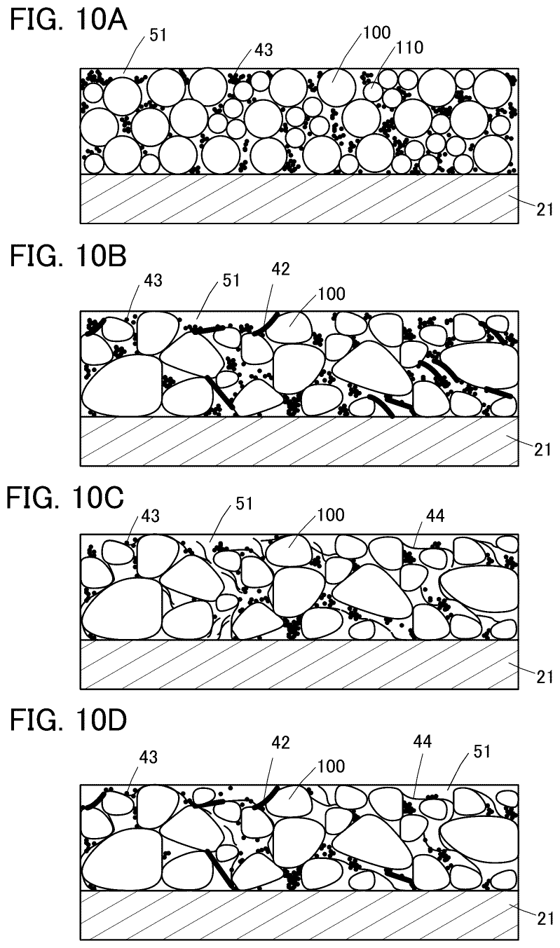

FIG. 10A illustrates an example of a schematic cross-sectional view of the positive electrode.

Metal foil can be used as a positive electrode current collector 21, for example. The positive electrode can be formed by applying slurry onto the metal foil and drying the slurry. Note that pressing may be performed after drying. The positive electrode is a component obtained by forming an active material layer over the positive electrode current collector 21.

Slurry refers to a material solution that is used to form the active material layer over the positive electrode current collector 21 and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

The positive electrode active material 100 has functions of taking in and releasing lithium ions in accordance with charging and discharging. For the positive electrode active material 100 used as one embodiment of the present invention, a material with little deterioration due to discharging and charging even at a high charge voltage can be used. In this specification and the like, unless otherwise specified, a charge voltage is shown with reference to the potential of lithium metal. In this specification and the like, a high charge voltage is a charge voltage, for example, higher than or equal to 4.5 V, preferably higher than or equal to 4.55 V, further preferably higher than or equal to 4.6 V, higher than or equal to 4.65 V, or higher than or equal to 4.7 V.

For the positive electrode active material 100 used as one embodiment of the present invention, any material can be used as long as it shows little deterioration due to discharging and charging even at a high charge voltage, and any of the materials described in Embodiment 1 or Embodiment 2 can be used. Note that for the positive electrode active material 100, two or more kinds of materials having different particle diameters can be used as long as the materials show little deterioration due to discharging and charging even at a high charge voltage.

A conductive material is also referred to as a conductivity-imparting agent or a conductive additive, and a carbon material can be used as the conductive material. A conductive material is attached between a plurality of active materials, whereby the plurality of active materials are electrically connected to each other, and the conductivity increases. Note that in this specification and the like, the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Specific examples of carbon materials that can be used as the conductive material include carbon black (e.g., furnace black or acetylene black).

FIG. 10A to FIG. 10D illustrate examples of the positive electrode active material layer.

FIG. 10A illustrates carbon black 43 that is an example of a conductive material and an electrolyte 51 included in a void portion positioned between the positive electrode active materials 100, and shows an example in which a second positive electrode active material 110 is also included in addition to the positive electrode active material 100.

In the positive electrode of the secondary battery, a binder (a resin) may be mixed in order to adhere the positive electrode current collector 21 such as metal foil and the active material to each other. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is preferably reduced to a minimum.

Although FIG. 10A illustrates an example in which the positive electrode active material 100 has a spherical shape, there is no particular limitation thereto. The cross-sectional shape of the positive electrode active material 100 may be an ellipse, a rectangle, a trapezoid, a triangle, a quadrilateral with rounded corners, or an asymmetrical shape, for example. For example, FIG. 10B shows an example in which the positive electrode active material 100 has a polygon shape with rounded corners.

In the positive electrode in FIG. 10B, graphene 42 is used as a carbon material used as the conductive material. In FIG. 10B, a positive electrode active material layer including the positive electrode active material 100, the graphene 42, and the carbon black 43 is formed over the positive electrode current collector 21.

In the step of mixing the graphene 42 and the carbon black 43 to obtain an electrode slurry, the weight of mixed carbon black is preferably 1.5 times to 20 times, further preferably 2 times to 9.5 times the weight of graphene.

When the graphene 42 and the carbon black 43 are mixed in the above range, the carbon black 43 is excellent in dispersion stability and an aggregated portion is unlikely to be generated at the time of preparing a slurry. When the graphene 42 and the carbon black 43 are mixed in the above range, the electrode density can be higher than that of a positive electrode using only the carbon black 43 as a conductive material. As the electrode density becomes higher, the capacity per unit weight can become higher. Specifically, the density of the positive electrode active material layer measured by gravimetry can be higher than or equal to 3.5 g/cc.

The electrode density is lower than that of a positive electrode using only graphene as a conductive material, but when a first carbon material (graphene) and a second carbon material (acetylene black) are mixed in the above range, fast charging can be achieved. Thus, use of such a mixed conductive material for secondary batteries for vehicles is particularly effective.

FIG. 10C illustrates an example of a positive electrode in which carbon fiber 44 is used instead of graphene. FIG. 10C illustrates an example different from FIG. 10B. With use of the carbon fiber 44, aggregation of the carbon black 43 can be prevented and the dispersibility can be increased.

In FIG. 10C, a region not filled with the positive electrode active material 100, the carbon fiber 44, or the carbon black 43 indicates a space or the binder.

FIG. 10D illustrates another example of a positive electrode. FIG. 10C illustrates an example in which the carbon fiber 44 is used in addition to the graphene 42. With use of both the graphene 42 and the carbon fiber 44, aggregation of carbon black such as the carbon black 43 can be prevented and the dispersibility can be further increased.

In FIG. 10D, a region not filled with the positive electrode active material 100, the carbon fiber 44, the graphene 42, or the carbon black 43 indicates a space or the binder.

A secondary battery can be manufactured by using any one of the positive electrodes in FIG. 10A to FIG. 10D; setting, in a container (e.g., an exterior body or a metal can) or the like, a stack in which a separator is provided over the positive electrode and a negative electrode is provided over the separator; and filling the container with an electrolyte solution.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the manufacture of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, the “passivation film” refers to a film without electrical conductivity or a film with extremely low electrical conductivity, and can inhibit the decomposition of the electrolyte solution at a potential at which a battery reaction occurs when the passivation film is formed on the active material surface, for example. It is further desirable that the passivation film can conduct lithium ions while inhibiting electrical conduction.

### <Conductive Material>

The conductive material is also referred to as a conductivity-imparting agent or a conductive additive, and a carbon material is used as the conductive material. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Active material layers such as the positive electrode active material layer and the negative electrode active material layer preferably include a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be manufactured by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound includes carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

The content of the conductive material to the total amount of the active material layer is preferably greater than or equal to 0.1 wt % and less than or equal to 10 wt %, further preferably greater than or equal to 0.5 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-including compound such as carbon black or graphite and a fibrous carbon-including compound such as carbon nanotube easily enter a microscopic space. A microscopic space means, for example, a region or the like between a plurality of active materials. When a carbon-including compound that easily enters a microscopic space and a sheet-like carbon-including compound, such as graphene, that can impart conductivity to a plurality of particles are used in combination, the density of the electrode is increased and an excellent conductive path can be formed. The battery obtained by the manufacture method of one embodiment of the present invention can have high capacity density and stability, and is effective as an in-vehicle battery.

### <Positive Electrode Current Collector>

As the current collector, a material that has high conductivity, such as a metal like stainless steel, gold, platinum, aluminum, or titanium, or an alloy thereof, can be used. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive material and a binder.

### <Negative Electrode Active Material>

As the negative electrode active material, for example, an alloy-based material or a carbon material can be used.

As the negative electrode active material, an element that enables charge and discharge reactions by an alloying reaction and a dealloying reaction with lithium can be used. For example, a material including at least one of silicon, tin, gallium, aluminum, germanium, lead, antimony, bismuth, silver, zinc, cadmium, indium, and the like can be used. Such elements have a higher capacity than carbon. In particular, silicon has a high theoretical capacity of 4200 mAh/g. For this reason, silicon is preferably used as the negative electrode active material. Alternatively, a compound including any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound including the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺ when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are included in the negative electrode active material and thus the negative electrode active material can be used in combination with a positive electrode active material that does not include lithium ions, such as V₂O₅ or Cr₃O₈. Note that in the case of using a material including lithium ions as a positive electrode active material, the composite nitride of lithium and a transition metal can be used as the negative electrode active material by extracting the lithium ions included in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not include a negative electrode active material at the completion of the manufacture of the battery may be used. As the negative electrode that does not include a negative electrode active material, for example, a negative electrode can be used in which only a negative electrode current collector is included at the completion of the manufacture of the battery and in which lithium ions extracted from the positive electrode active material due to charging of the battery are deposited as lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not include a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. As another film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case where the negative electrode that does not include a negative electrode active material is used, a negative electrode current collector having projections and depressions can be used. In the case where the negative electrode current collector having projections and depressions is used, a depression of the negative electrode current collector becomes a cavity in which lithium included in the negative electrode current collector is easily deposited, so that the lithium can be inhibited from having a dendrite-like shape when being deposited.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte]

As one mode of the electrolyte, an electrolyte solution including a solvent and an electrolyte dissolved in the solvent can be used. The solvent of the electrolyte solution is preferably an aprotic organic solvent, and one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds thereof can be used in an appropriate combination at an appropriate ratio, for example.

Alternatively, the use of one or more of ionic liquids (normal temperature molten salts) which have features of non-flammability and non-volatility as a solvent of the electrolyte solution can prevent a power storage device from exploding or catching fire even when the power storage device internally shorts out or the internal temperature increases owing to overcharging or the like. An ionic liquid includes a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one kind of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more kinds of these lithium salts can be used in an appropriate combination at an appropriate ratio.

Furthermore, an additive agent such as vinylene carbonate, propane sultone (PS), tert-butylbenzene (TBB), fluoroethylene carbonate (FEC), lithium bis(oxalate)borate (LiBOB), a dinitrile compound such as succinonitrile or adiponitrile, fluorobenzene, or ethylene glycol bis(propionitrile) ether may be added to the electrolyte solution. The concentration of such an additive agent in the solvent in which the electrolyte is dissolved is, for example, higher than or equal to 0.1 wt % and lower than or equal to 5 wt %. In particular, adiponitrile is expected to increase resistance to high voltage owing to interaction with the surface of the positive electrode active material 100 of one embodiment of the present invention, and thus is preferably used for a secondary battery including the positive electrode active material of one embodiment of the present invention, in which case the secondary battery can have a higher energy density. Note that the additive agent may become a coating film attached to an active material surface in aging treatment of a secondary battery. Thus, in a secondary battery that has been charged and discharged even a little, at least part of the additive agent is not detected in the electrolyte solution in some cases.

### [Separator]

When the electrolyte includes an electrolyte solution, a separator is placed between the positive electrode and the negative electrode. As the separator, for example, a fiber including cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Structure of Secondary Battery Including Solid Electrolyte Layer>

A structure of a secondary battery including a solid electrolyte layer is described below as another structure example of a secondary battery.

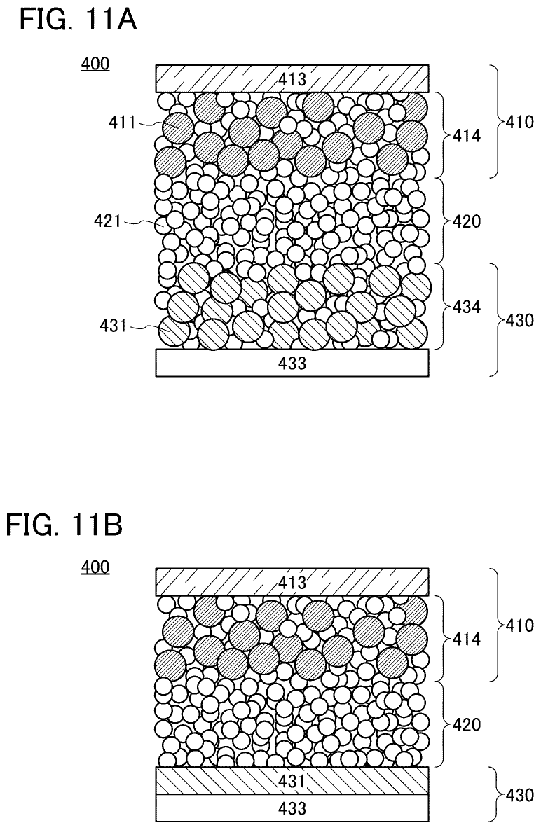

As illustrated in FIG. 11A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material manufactured by the manufacture method described in the above embodiments is used. The positive electrode active material layer 414 may include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used for the negative electrode 430, the negative electrode 430 that does not include the solid electrolyte 421 can be formed, as illustrated in FIG. 11B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ or Li_{3.25}Ge_{0.25}P_{0.75}S₄), sulfide glass (e.g., 70Li₂S·30P2S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₋ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it includes aluminum and titanium, each of which is the element the positive electrode active material used in the secondary battery 400 of one embodiment of the present invention is allowed to include, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X, S, P, As, Mo, W, or the like) and has a structure in which MO₆ octahedrons and XO₄ tetrahedrons that share corners are arranged three-dimensionally.

This embodiment can be used in combination with the other embodiments.

### Embodiment 4

In this embodiment, examples of the shape of a secondary battery including the positive electrode manufactured by the manufacture method described in the above embodiment are described.

### [Coin-Type Secondary Battery]

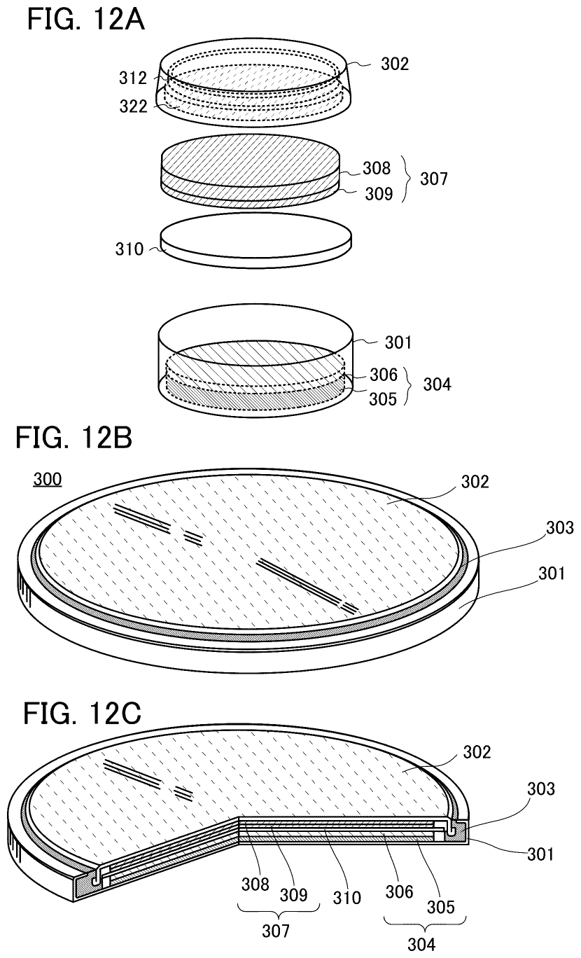

An example of a coin-type secondary battery is described here. FIG. 12A is an exploded perspective view of a coin-type (single-layer flat type) secondary battery, FIG. 12B is an external view thereof, and FIG. 12C is a cross-sectional view thereof. Coin-type secondary batteries are mainly used in small electronic devices.

Note that, for easy understanding, FIG. 12A is a schematic view illustrating overlap (a vertical relation and a positional relation) between components. Thus, FIG. 12A and FIG. 12B do not completely correspond with each other.

In FIG. 12A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 12A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 12C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

With the above-described structure, the coin-type secondary battery 300 can have high discharge capacity and excellent cycle performance.

### [Cylindrical Secondary Battery]

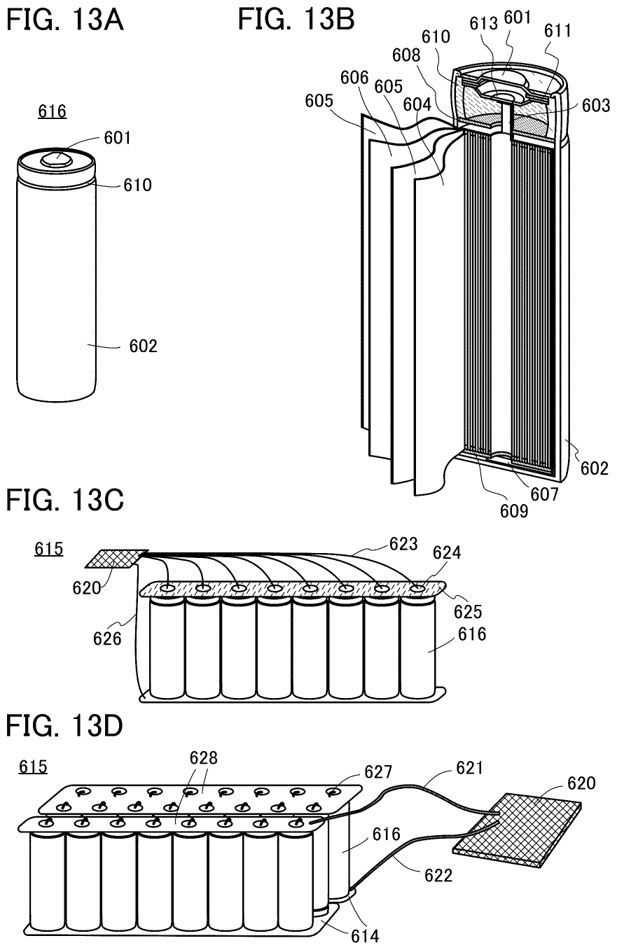

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 13B schematically illustrates a cross section of the cylindrical secondary battery. The cylindrical secondary battery illustrated in FIG. 13B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material 100 described in Embodiments 1, 2, and the like is used for the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 13C illustrates an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging or/and overdischarging can be used.

FIG. 13D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

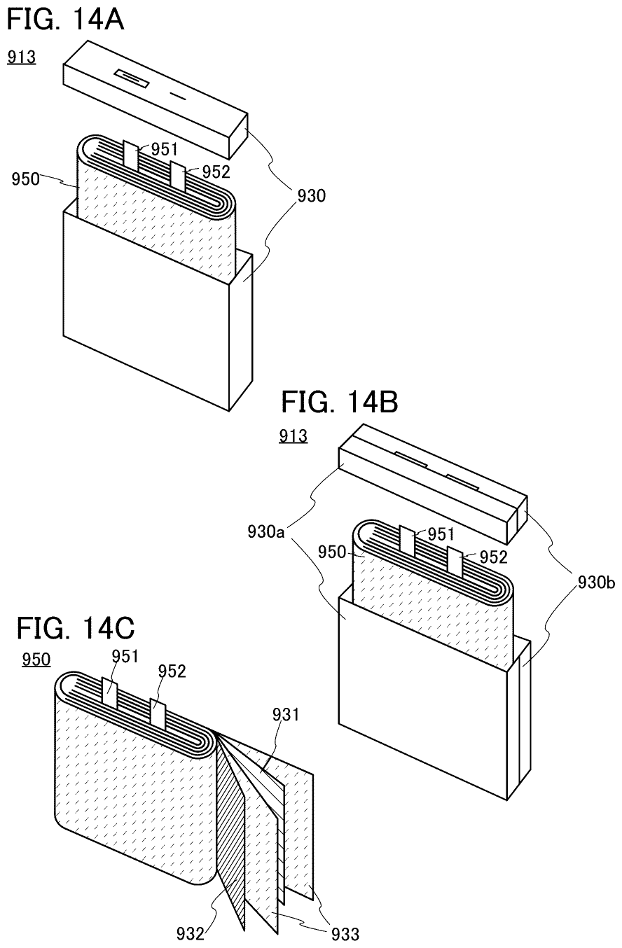

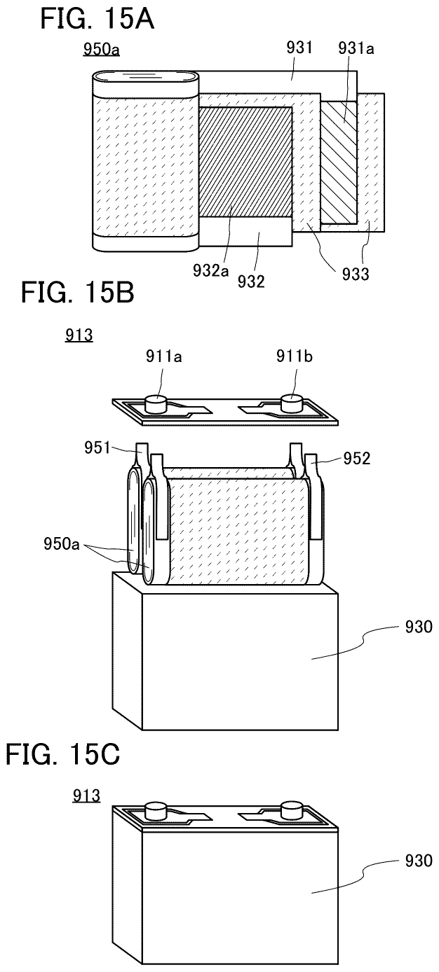

Structure examples of secondary batteries are described with reference to FIG. 14 and FIG. 15.

A secondary battery 913 illustrated in FIG. 14A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 14A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 14B, the housing 930 illustrated in FIG. 14A may be formed using a plurality of materials. For example, in the secondary battery 913 illustrated in FIG. 14B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 15, the secondary battery 913 may include a wound body 950a. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 described in Embodiments 1, 2, and the like is used for the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 15B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 15C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, the safety valve is a valve to be released when the internal pressure of the housing 930 reaches a predetermined pressure.

As illustrated in FIG. 15B, the secondary battery 913 may include a plurality of the wound bodies 950a. The use of the plurality of wound bodies 950a enables the secondary battery 913 to have higher discharge capacity. The description of the secondary battery 913 illustrated in FIG. 14A to FIG. 14C can be referred to for the other components of the secondary battery 913 illustrated in FIG. 15A and FIG. 15B.

### <Laminated Secondary Battery>

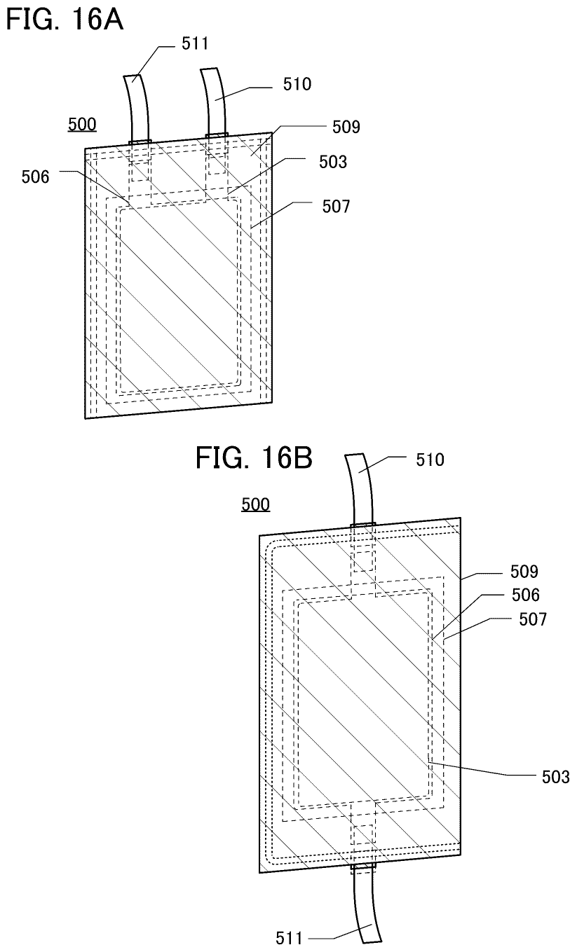

Next, examples of the appearance of a laminated secondary battery are illustrated in FIG. 16A and FIG. 16B. In FIG. 16A and FIG. 16B, a positive electrode 503, a negative electrode 506, a separator 507, an exterior body 509, a positive electrode lead electrode 510, and a negative electrode lead electrode 511 are included.

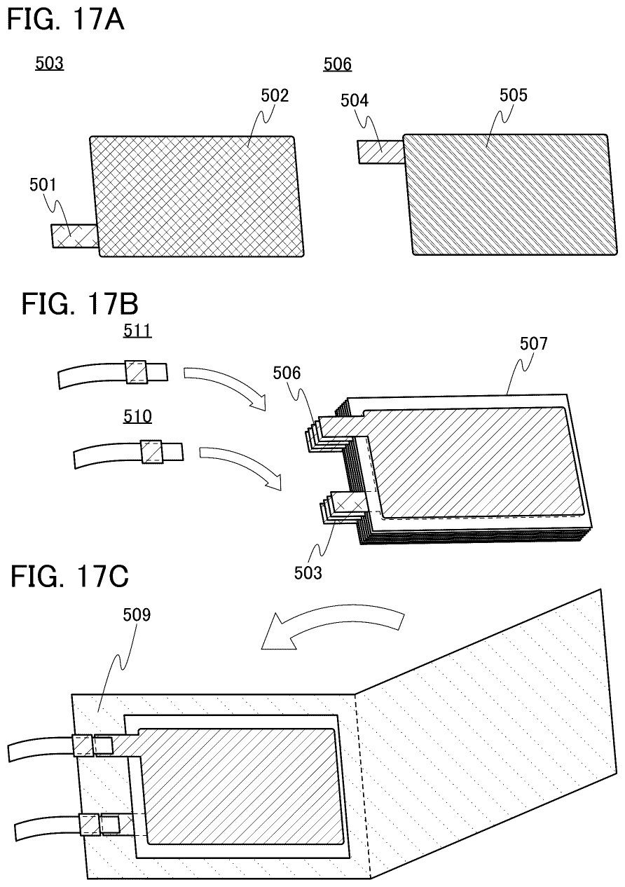

FIG. 17A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 17A.

### <Method for Manufacturing Laminated Secondary Battery>

An example of a method for manufacturing the laminated secondary battery whose external view is illustrated in FIG. 16A will be described with reference to FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion indicated by a dashed line, as illustrated in FIG. 17C. Then, the outer edges of the exterior body 509 are bonded to each other. The bonding is performed by thermocompression bonding, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is bonded. In this manner, the laminated secondary battery 500 can be manufactured.

The positive electrode active material 100 described in Embodiments 1, 2, and the like is used for the positive electrode 503, whereby the secondary battery 500 can have high capacity, high discharge capacity, and excellent cycle performance.

### [Examples of Battery Pack]

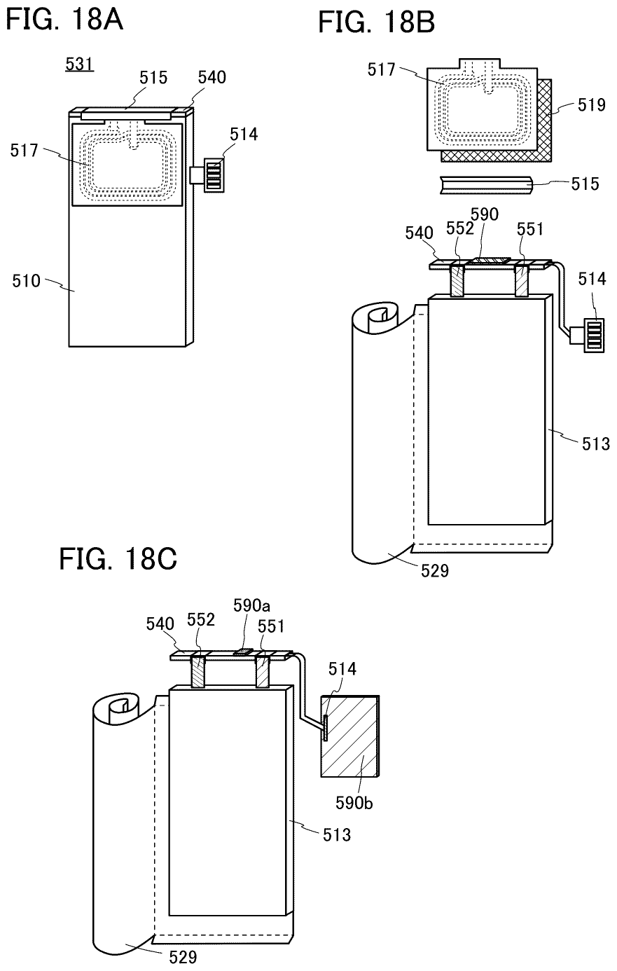

Examples of a secondary battery pack of one embodiment of the present invention that is capable of wireless charging using an antenna will be described with reference to FIG. 18.

FIG. 18A is a diagram illustrating the appearance of a secondary battery pack 531 that has a rectangular solid shape with a small thickness (also referred to as a flat plate shape with a certain thickness). FIG. 18B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 18B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 18C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### Embodiment 5

In this embodiment, examples of vehicles each including the secondary battery of one embodiment of the present invention will be described.

The secondary battery can be used in vehicles, typically automobiles. Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. The vehicles are not limited to automobiles. Examples of the vehicles include a train, a monorail train, a ship, a submarine (a deep-submergence vehicle and an unmanned submarine), a flying object (a helicopter, an unmanned aircraft (a drone), an airplane, a rocket, and an artificial satellite), an electric bicycle, and an electric motorcycle, and the secondary battery of one embodiment of the present invention can be used for the vehicles.

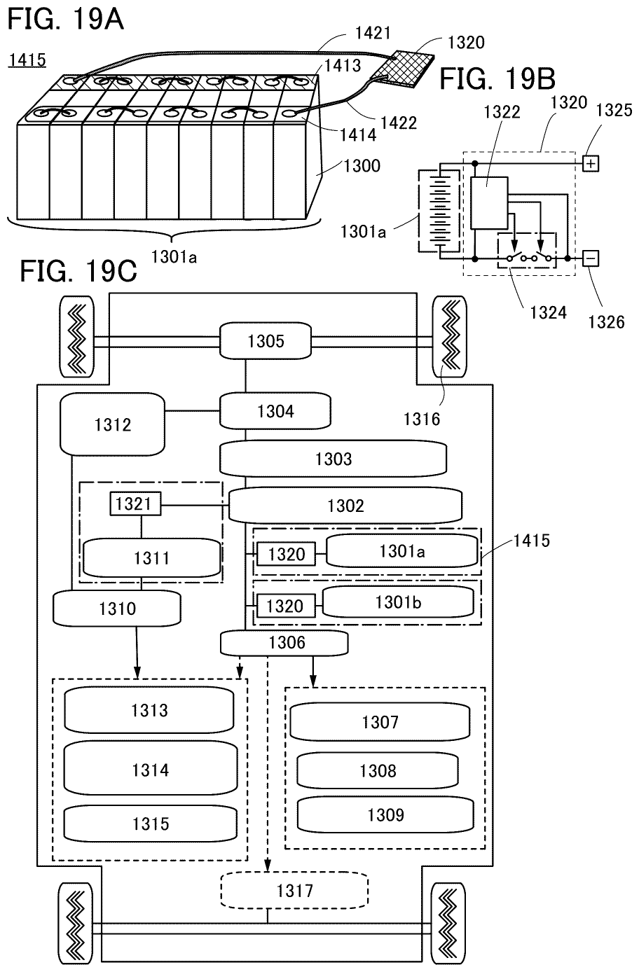

As illustrated in FIG. 19C, the electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 14C or FIG. 15A or the stacked-layer structure illustrated in FIG. 16A or FIG. 16B. Alternatively, the all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

Next, the first battery 1301a is described with reference to FIG. 19A.

FIG. 19A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and/or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region including In as its main component (the first region) and the region including Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, a high on-state current (Ion), a high field-effect mobility (p), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of single crystal Si, and thus shows a smaller change in characteristics than the single crystal even when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 described in Embodiments 1, 2, and the like, the synergy on safety can be obtained. The secondary battery whose positive electrode uses the positive electrode active material 100 described in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to eliminate ten causes of instability, such as a micro short circuit. Examples of functions of eliminating the ten causes of instability include prevention of overcharge, prevention of overcurrent, control of overheating during charge, maintenance of cell balance of an assembled battery, prevention of overdischarge, a battery indicator, automatic control of charge voltage and current amount according to temperature, control of the amount of charge current according to the degree of deterioration, detection of abnormal behavior due to a micro short circuit, and anomaly prediction regarding a micro short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

Next, FIG. 19B illustrates an example of a block diagram of the battery pack 1415 illustrated in FIG. 19A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharging and are more likely to deteriorate due to a phenomenon called sulfation. There is an advantage that the second battery 1311 can be maintenance-free when a lithium-ion battery is used; however, in the case of long-term use, for example three years or more, anomaly that is difficult to determine at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a secondary battery used, so that fast charging can be performed.

Although not illustrated, in connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200 V outlet with 50 kW, for example. Furthermore, charging can be performed with electric power supplied from external charging equipment by a contactless power feeding method or the like.

For fast charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiments 1, 2, and the like can increase the operating voltage of the secondary battery, and the increase in charge voltage can increase the available capacity. Moreover, using the positive electrode active material 100 described in Embodiments 1, 2, and the like in the positive electrode can provide an in-vehicle secondary battery having excellent cycle performance.

Next, examples in which the secondary battery of one embodiment of the present invention is mounted on a vehicle, typically a transport vehicle, will be described.

Mounting the secondary battery illustrated in any of FIG. 13D, FIG. 15C, and FIG. 19A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

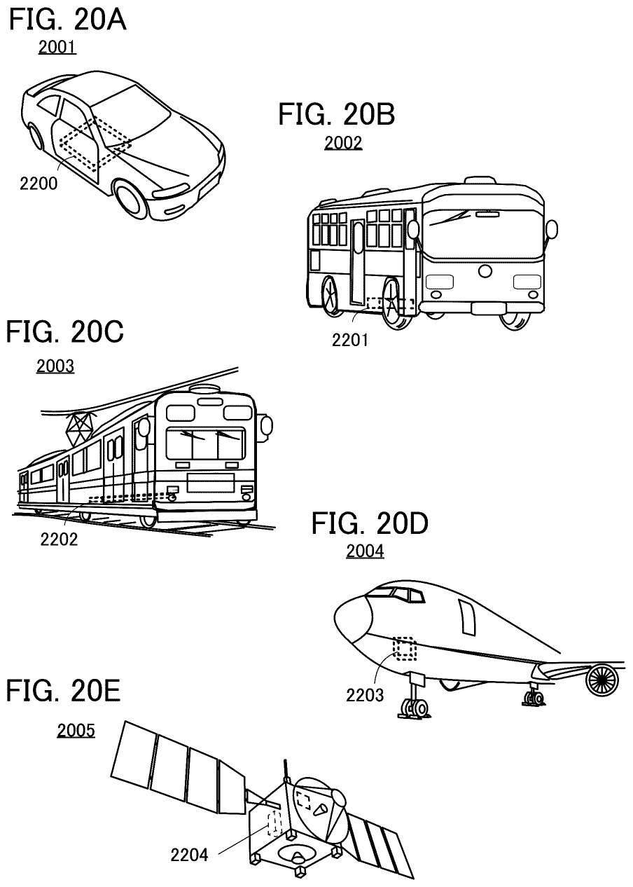

FIG. 20A to FIG. 20D illustrate examples of transport vehicles using one embodiment of the present invention. An automobile 2001 illustrated in FIG. 20A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 20A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless power feeding system, or the like. In charging, a given method such as CHAdeMO (registered trademark) or Combined Charging System can be employed as a charge method, the standard of a connector, or the like as appropriate. Charging equipment may be a charge station provided in a commerce facility or a power source in a house. For example, with the use of the plug-in system, the power storage device mounted on the automobile 2001 can be charged by being supplied with electric power from the outside. Charging can be performed by converting AC electric power into DC electric power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of electric power between two vehicles. Furthermore, a solar cell may be provided in the exterior of the vehicle to charge the secondary battery while the vehicle is stopped or while the vehicle is moving. To supply power in such a contactless manner, an electromagnetic induction method or a magnetic resonance method can be used.

FIG. 20B illustrates a large transporter 2002 having a motor controlled by electricity, as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage, for example. A battery pack 2201 has the same function as that in FIG. 20A except, for example, the number of secondary batteries configuring the secondary battery module; thus, the description is omitted.

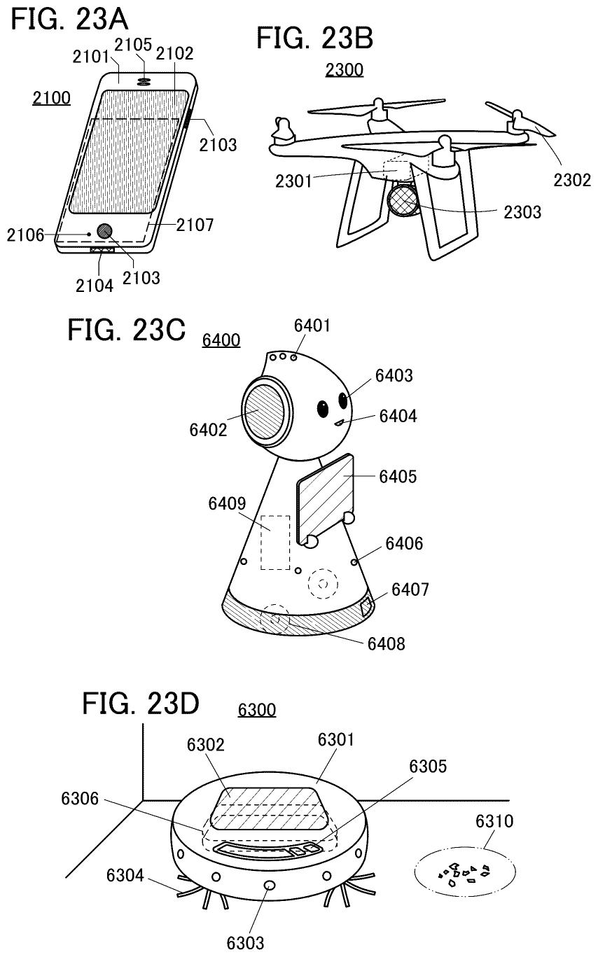

FIG. 20C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield. A battery pack 2202 has the same function as that in FIG. 23A except, for example, the number of secondary batteries configuring the secondary battery module; thus, the description is omitted.

FIG. 20D illustrates an aircraft 2004 having a combustion engine as an example. The aircraft 2004 illustrated in FIG. 20D can be regarded as a part of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has a maximum voltage of 32 V, for example. The battery pack 2203 has the same function as that in FIG. 20A except, for example, the number of secondary batteries configuring the secondary battery module; thus, the description is omitted.

FIG. 20E illustrates an artificial satellite 2005 including a secondary battery 2204 as an example. Because the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

This embodiment can be used in combination with the other embodiments.

### Embodiment 6

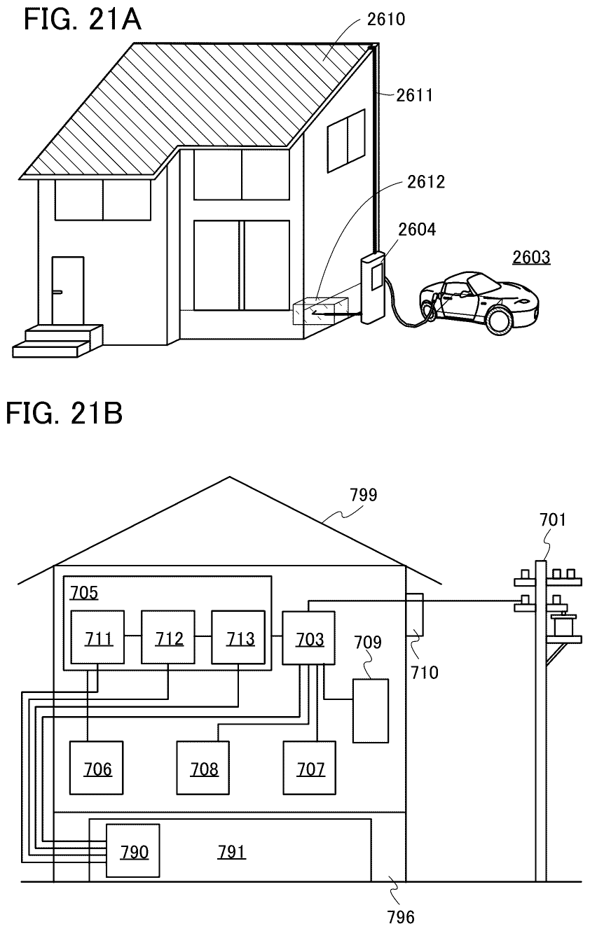

In this embodiment, examples in which the secondary battery of one embodiment of the present invention is mounted on a building will be described with reference to FIG. 21A and FIG. 21B.

A house illustrated in FIG. 21A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 21B illustrates an example of a power storage device of one embodiment of the present invention. As illustrated in FIG. 21B, a power storage device 791 of one embodiment of the present invention is provided in an underfloor space 796 of a building 799. The power storage device 791 may be provided with the control circuit described in Embodiment 7, and when a secondary battery including a positive electrode using the positive electrode active material 100 described in Embodiments 1, 2, and the like is used for the power storage device 791, the synergy on safety can be obtained. The secondary battery including the control circuit described in Embodiment 7 and the positive electrode using the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be used in combination with the other embodiments.

### Embodiment 7

This embodiment describes examples in which the lithium-ion battery of one embodiment of the present invention is mounted on a two-wheeled vehicle and a bicycle as examples of mounting a secondary battery on a vehicle.

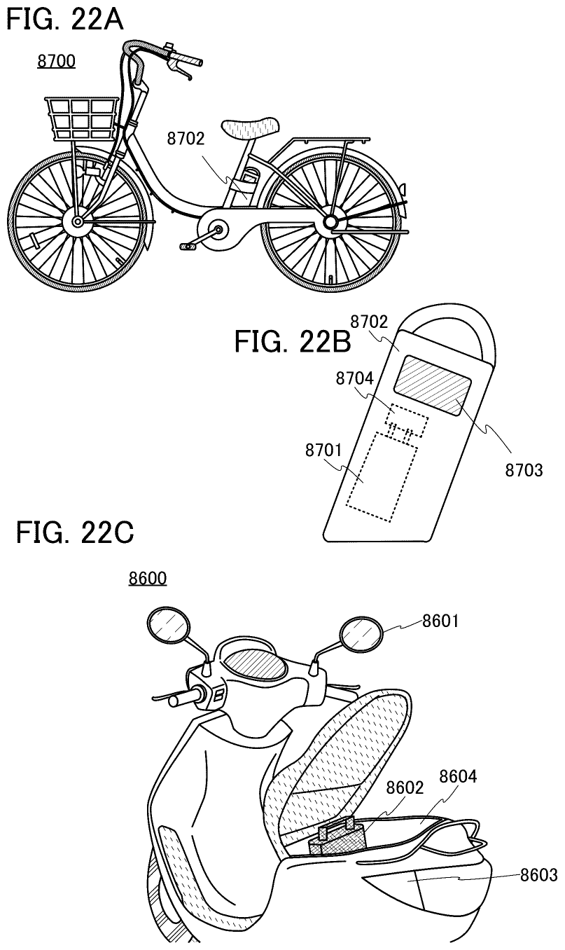

FIG. 22A illustrates an example of an electric bicycle using the power storage device of one embodiment of the present invention. The power storage device of one embodiment of the present invention can be used for an electric bicycle 8700 illustrated in FIG. 22A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 22B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. When the control circuit 8704 is used in combination with a secondary battery including a positive electrode using the positive electrode active material 100 described in Embodiments 1, 2, and the like, the synergy on safety can be obtained. The secondary battery including the positive electrode using the positive electrode active material 100 described in Embodiments 1, 2, and the like and the control circuit 8704 can contribute greatly to elimination of accidents due to secondary batteries, such as fires.

FIG. 22C illustrates an example of a two-wheeled vehicle including the power storage device of one embodiment of the present invention. A motor scooter 8600 illustrated in FIG. 22C includes a power storage device 8602, side mirrors 8601, and indicator lights 8603. The power storage device 8602 can supply electricity to the indicator lights 8603. The power storage device 8602 including a plurality of secondary batteries each including a positive electrode using the positive electrode active material 100 described in Embodiments 1, 2, and the like can have high capacity and contribute to a reduction in size.

In the motor scooter 8600 illustrated in FIG. 22C, the power storage device 8602 can be stored in an under-seat storage unit 8604. The power storage device 8602 can be stored in the under-seat storage unit 8604 even when the under-seat storage unit 8604 is small.

This embodiment can be used in combination with the other embodiments.

In this embodiment, examples of electronic devices each including the secondary battery of one embodiment of the present invention will be described. Examples of electronic devices including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone. The secondary battery of one embodiment of the present invention includes the positive electrode active material 100 with a relatively small particle diameter, and thus is particularly suitable for an electronic device that is required to have high output, an electronic device used in a low-temperature environment, and the like.

FIG. 23A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiments 1, 2, and the like achieves a high capacity and a structure that accommodates space saving due to a reduction in size of the housing.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 23B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 described in Embodiments 1, 2, and the like has a high energy density and a high level of safety, and thus can be used safely for a long time over a long period of time and is preferable as the secondary battery included in the unmanned aircraft 2300.

FIG. 23C illustrates an example of a robot. A robot 6400 illustrated in FIG. 23C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 described in Embodiments 1, 2, and the like has a high energy density and a high level of safety, and thus can be used safely for a long time over a long period of time and is preferable as the secondary battery 6409 included in the robot 6400.

FIG. 23D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 according to one embodiment of the present invention and a semiconductor device or an electronic component. A secondary battery including a positive electrode using the positive electrode active material 100 described in Embodiments 1, 2, and the like has a high energy density and a high level of safety, and thus can be used safely for a long time over a long period of time and is preferable as the secondary battery 6306 included in the cleaning robot 6300.

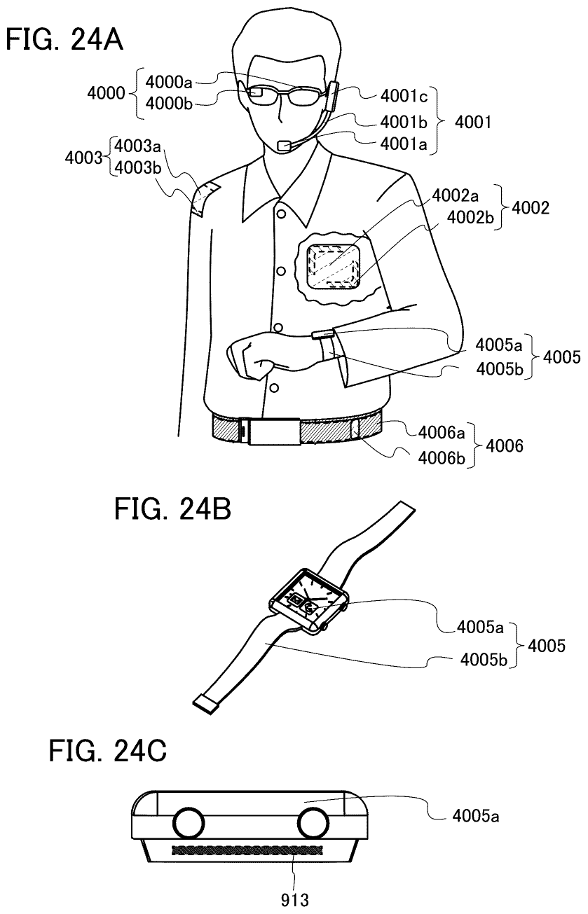

FIG. 24A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be mounted in a glasses-type device 4000 illustrated in FIG. 24A. The glasses-type device 4000 includes a frame 4000a and a display portion 4000b. The secondary battery is mounted in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 described in Embodiments 1, 2, and the like has a high energy density and achieves a structure that accommodates space saving due to a reduction in size of the housing.

The secondary battery of one embodiment of the present invention can be mounted in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 described in Embodiments 1, 2, and the like has a high energy density and achieves a structure that accommodates space saving due to a reduction in size of the housing.

The secondary battery of one embodiment of the present invention can be mounted in a device 4002 that can be attached directly to a body. A secondary battery 4002b can be provided in a thin housing 4002a of the device 4002. A secondary battery including a positive electrode using the positive electrode active material 100 described in Embodiments 1, 2, and the like has a high energy density and achieves a structure that accommodates space saving due to a reduction in size of the housing.

The secondary battery of one embodiment of the present invention can be mounted in a device 4003 that can be attached to clothes. A secondary battery 4003b can be provided in a thin housing 4003a of the device 4003. A secondary battery including a positive electrode using the positive electrode active material 100 described in Embodiments 1, 2, and the like has a high energy density and achieves a structure that accommodates space saving due to a reduction in size of the housing.

The secondary battery of one embodiment of the present invention can be mounted in a belt-type device 4006. The belt-type device 4006 includes a belt portion 4006a and a wireless power feeding and receiving portion 4006b, and the secondary battery can be mounted in the inner region of the belt portion 4006a. A secondary battery including a positive electrode using the positive electrode active material 100 described in Embodiments 1, 2, and the like has a high energy density and achieves a structure that accommodates space saving due to a reduction in size of the housing.

The secondary battery of one embodiment of the present invention can be mounted in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 described in Embodiments 1, 2, and the like has a high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 24B illustrates a perspective view of the watch-type device 4005 that is detached from an arm.

FIG. 24C illustrates a side view. FIG. 24C illustrates a state where the secondary battery 913 is incorporated in the inner region. The secondary battery 913 is the secondary battery described in Embodiment 4. The secondary battery 913 is provided at a position overlapped by the display portion 4005a, can have a high density and high capacity, and is small and lightweight.

Since the secondary battery in the watch-type device 4005 is required to be small and lightweight, the use of the positive electrode active material 100 described in Embodiments 1, 2, and the like in the positive electrode of the secondary battery 913 enables the secondary battery 913 to have a high energy density and a small size.

This embodiment can be used in combination with the other embodiments.

### Example 1

In this example, the positive electrode active material 100 of one embodiment of the present invention was formed and features thereof were analyzed.

### <Manufacture of Positive Electrode Active Material>

Samples manufactured in this example are described with reference to the manufacture methods illustrated in FIG. 8 and FIG. 9.

As LiCoO₂ in Step S14 in FIG. 8, commercially available lithium cobalt oxide (CELLSEED C-5H manufactured by Nippon Chemical Industrial Co., Ltd.) including cobalt as the transition metal M and not including any additive element was prepared. The initial heating in Step S15 was performed on the lithium cobalt oxide, which was put in a crucible covered with a lid, in a muffle furnace at 850° C. for 2 hours. After the muffle furnace was filled with an oxygen atmosphere, no flowing was performed (O₂ purging). The collected amount after the initial heating showed a slight decrease in weight. The decrease in weight was probably caused by elimination of impurities such as lithium carbonate from the lithium cobalt oxide.

In accordance with Step S20a and Step S40 illustrated in FIG. 9A and FIG. 9C, addition of Mg and F and addition of Ni and Al were separately performed as addition of the additive elements.

First, LiF was prepared as the F source and MgF₂ was prepared as the Mg source, in accordance with Step S21 shown in FIG. 9A. The LiF and MgF₂ were weighed such that LiF:MgF₂=1:3 (molar ratio). Then, LiF and MgF₂ were mixed into dehydrated acetone and the mixture was stirred at a rotational speed of 400 rpm for 12 hours (Step S22), whereby the additive element source (A1 source) was manufactured (Step S23). In the mixing, a ball mill was used and a grinding medium was zirconium oxide balls. The F source and Mg source weighing approximately 10 g in total were put in a 45-mL-capacity container of the mixing ball mill together with 20 mL of dehydrated acetone and 22 g of zirconium oxide balls (1 mmφ) and mixed. After the mixing, acetone was evaporated and the mixture was made to pass through a sieve with an aperture of 300 μm, whereby the additive element A1 was obtained.

Next, as Step S31, the A1 source was weighed such that the number of magnesium atoms of the A1 source was 1% with respect to the number of cobalt atoms of the lithium cobalt oxide after the initial heating, and was mixed by a dry method with the lithium cobalt oxide after the initial heating. At this time, stirring was performed at a rotational speed of 150 rpm for 1 hour. These conditions were milder than those of the stirring in the production of the A1 source. Finally, the mixture was made to pass through a sieve with an aperture of 300 μm, whereby the mixture 903 having a uniform particle diameter was obtained (Step S32).

Next, in Step S33, the mixture 903 was heated in a muffle furnace. The heating conditions were 900° C. and 20 hours. During the heating, a lid was put on a crucible including the mixture 903. The muffle furnace was filled with an atmosphere including oxygen and entry and exit of the oxygen were blocked (O2 purged). After the heating, the mixture was made to pass through a sieve with an aperture of 53 μm, whereby a composite oxide including Mg and F was obtained (Step S34a).

Then, as Step S51, the composite oxide and the additive element source (A2 source) were mixed. In accordance with Step S41 to S43 illustrated in FIG. 9C, nickel hydroxide on which a grinding step was performed was prepared as the Ni source and aluminum hydroxide on which a grinding step was performed was prepared as the A1 source. The A2 source was weighed such that the number of nickel atoms of the nickel hydroxide was 0.5% with respect to the number of cobalt atoms of the composite oxide and the number of aluminum atoms of the aluminum hydroxide was 0.5% with respect to the number of cobalt atoms of the composite oxide, and was mixed with the composite oxide by a dry method. At this time, stirring was performed at a rotational speed of 150 rpm for 1 hour. In the mixing, a ball mill was used and a grinding medium was zirconium oxide balls. The composite oxide and the additive element source (A2 source) weighing approximately 7.5 g in total were put in a 45-mL-capacity container of the mixing ball mill together with 22 g of zirconium oxide balls (1 mmφ) and mixed. These conditions were milder than those of the stirring in the production of the A1 source. Finally, the mixture was made to pass through a sieve with an aperture of 300 μm, whereby a mixture 904 having a uniform particle diameter was obtained (Step S52).

Next, in Step S53, the mixture 904 was heated in a muffle furnace. The heating conditions were 850° C. and 10 hours. During the heating, a lid was put on a crucible including the mixture 904. The muffle furnace was filled with an atmosphere including oxygen and entry and exit of the oxygen were blocked (O₂ purged). After the heating, the mixture was made to pass through a sieve with an aperture of 53 μm, whereby lithium cobalt oxide including Mg, F, Ni, and Al was obtained (Step S54). The positive electrode active material (composite oxide) obtained in the above manner was used as Sample 1-1.

Sample 1-2 was manufactured in a manner similar to that of Sample 1-1 except that the heating conditions were 900° C. and 5 hours in Step S33 and the heating conditions were 850° C. and 2 hours in Step S53.

Sample 1-3 was manufactured in a manner similar to that of Sample 1-1 except that the heating conditions were 850° C. and 20 hours in Step S33 and the heating conditions were 850° C. and 2 hours in Step S53.

As another comparative example, lithium cobalt oxide (CELLSEED C-5H manufactured by Nippon Chemical Industrial Co., Ltd.) without any particular treatment was used as Sample 2.

### <Powder Resistance>

The powder volume resistivity of each of Sample 1-1, Sample 1-2, Sample 1-3, and Sample 2 was measured.

The powder volume resistivity was measured by the method described in <<Powder resistance measurement>> in Embodiment 1. As a measurement apparatus, MCP-PD51 manufactured by Mitsubishi Chemical Analytech Co., Ltd. was used, and Samples 1-1 to 1-3 were measured with the use of the high resistivity meter Hiresta-UP. Sample 2 was measured with a low resistivity meter Loresta-GP. The measurement was performed in an environment where the temperature was 25° C. and the dew point was lower than or equal to −40° C.

The powder volume resistivity of each sample was obtained by measuring the electric resistance and volume of the powder of approximately 2 g set on a measurement area, under pressures of 16 MPa, 25 MPa, 38 MPa, 51 MPa, and 64 MPa. The results are shown in Table 2 (units are all Ω·cm)

TABLE 2

| | Pressure during powder resistance measurement | | | | |
|---|---|---|---|---|---|
| Sample | 13 MPa | 25 MPa | 38 MPa | 51 MPa | 64 MPa |
| 1-1 | 5.2E+08 | 2.2E+08 | 1.2E+08 | 7.5E+07 | 4.8E+07 |
| 1-2 | 3.7E+10 | 1.5E+10 | 8.7E+09 | 5.4E+09 | 3.6E+09 |
| 1-3 | 3.6E+09 | 1.6E+09 | 9.1E+08 | 5.8E+08 | 4.2E+08 |
| 2 | 6.1E+03 | 4.8E+03 | 4.4E+03 | 4.2E+03 | 4.2E+03 |

The above results show that the powder volume resistivity of Sample 1-1 to Sample 1-3 measured under a pressure of 64 MPa is higher than or equal to 5.0×10³ Ω·cm and lower than or equal to 1.0×10¹² Ω·cm. In particular, the volume resistivity of Sample 1-2 is higher than or equal to 1.0×10⁹ Ω·cm and lower than or equal to 1.0×10¹⁰ Ω·cm, which is the highest.

### <Particle Size Distribution>

The particle size distribution of the powder of each of Sample 1-1, Sample 1-2, Sample 1-3, and Sample 2 was measured.

The particle size distribution of the powder was measured by the measurement method described in <<Particle size distribution measurement>> in Embodiment 1. The particle size distribution was measured with the use of a laser diffraction particle size distribution measurement apparatus SALD-2200 manufactured by Shimadzu Corporation.

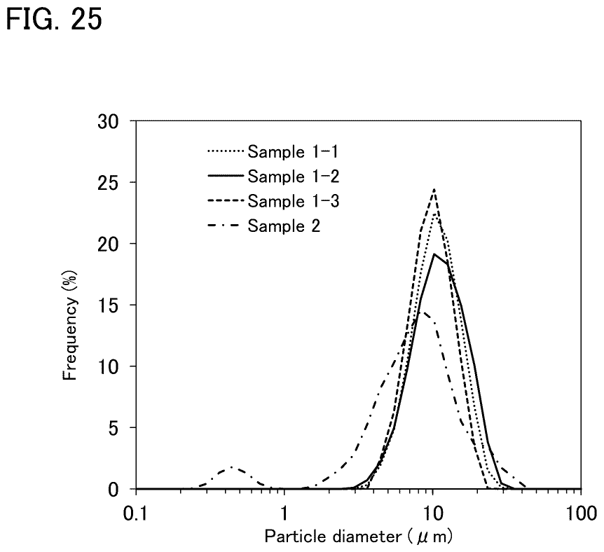

FIG. 25 shows the measurement results of particle size distributions of Samples 1-1 to 1-3 and Sample 2.

Table 3 shows the 10% particle diameter (D10), the 50% particle diameter (D50), and the 90% particle diameter (D90) of Samples 1-1 to 1-3 and Sample 2.

TABLE 3

| Sample | D10 (μm) | D50 (μm) | D90 (μm) |
|---|---|---|---|
| 1-1 | 5.804 | 9.529 | 15.129 |
| 1-2 | 5.724 | 9.971 | 16.980 |
| 1-3 | 5.586 | 8.814 | 13.639 |
| 2 | 2.760 | 7.029 | 15.341 |

From the above results, in the particle size distribution of Sample 1-1 to Sample 1-3, D50 is greater than or equal to 7 μm and less than or equal to 12 μm. The distribution tends to be sharper and the D50 tends to be larger in Sample 1-1 to Sample 1-3 of one embodiment of the present invention than in Sample 2 not subjected to the mixing or the heat treatment of the additive element source, in particular. This is probably because the minute lithium cobalt oxide of 1 μm or less was sintered with another particle.

### <STEM and EDX>

Next, Sample 1-2 was subjected to STEM-EDX line analysis.

As pretreatment before analysis, Sample 1-2 was sliced by an FIB method (μ-sampling method).

STEM and EDX were performed with the following apparatuses under the following conditions.

### <<STEM Observation>>

Scanning transmission electron microscope: HD-2700 manufactured by Hitachi High-Tech Corporation
Observation condition, acceleration voltage: 200 kV
Magnification accuracy: ±3%

### <<EDX>>

Analysis method: energy dispersive X-ray spectroscopy (EDX)
Scanning transmission electron microscope: HD-2700 manufactured by Hitachi High-Tech Corporation
Acceleration voltage: 200 kV
Beam diameter: approximately 0.2 nmφ
Element analysis apparatus: equipped with two units of Octane T Ultra W
X-ray detector: Si drift detector
Energy resolution: approximately 130 eV
X-ray extraction angle: 25°
Solid angle: 2 sr
Number of captured pixels: 512×400

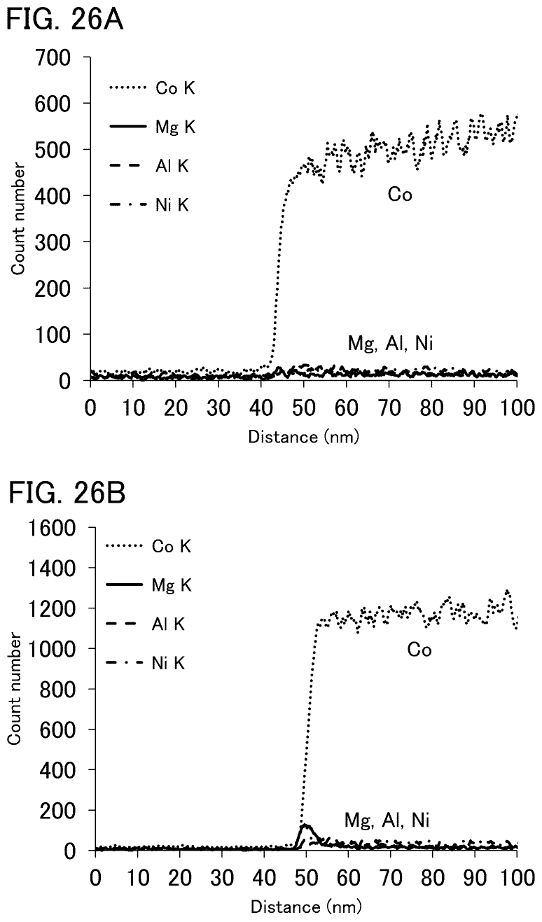

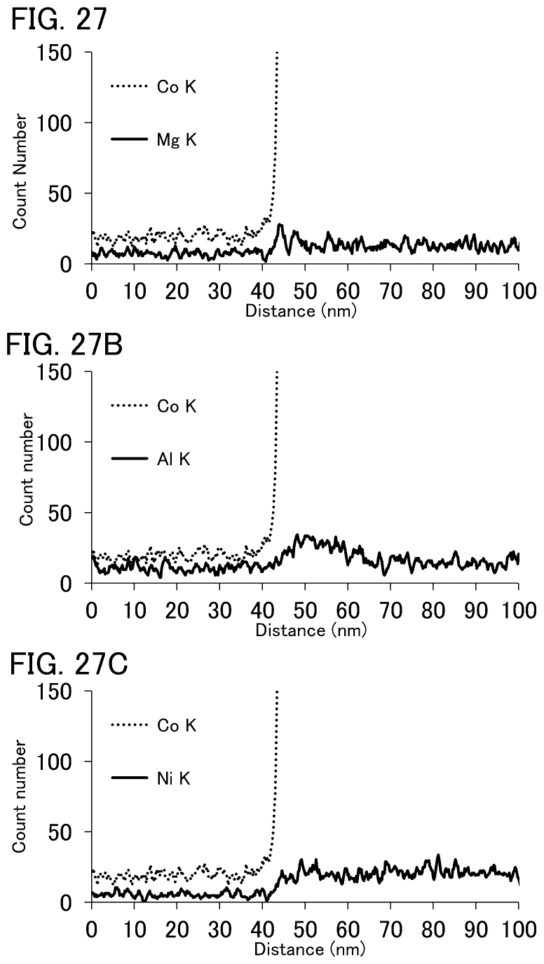

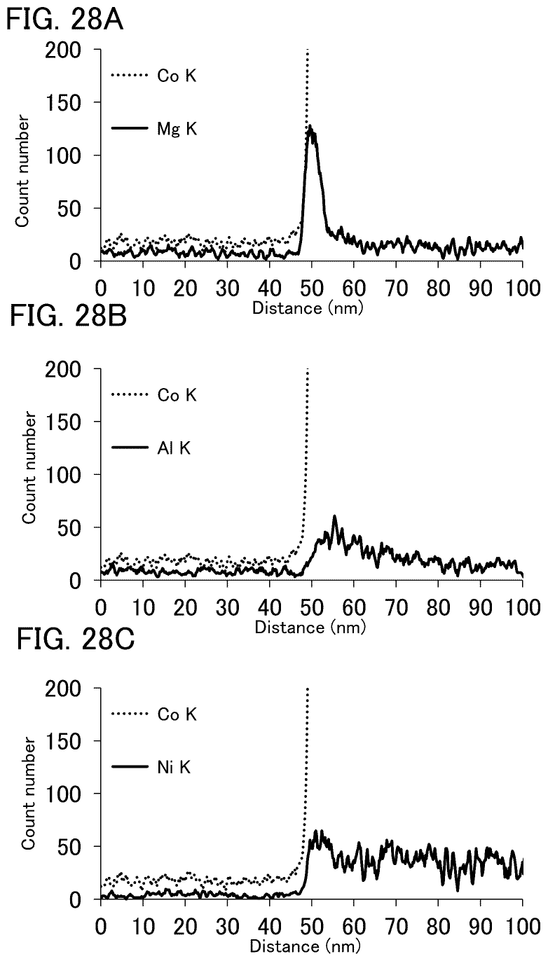

FIG. 26A, FIG. 27A, FIG. 27B, and FIG. 27C are each a profile (count number) of STEM-EDX line analysis in the basal region (the plane with (001) orientation) of Sample 1-2. FIG. 26B, FIG. 28A, FIG. 28B, and FIG. 28C are each a profile (count number) of STEM-EDX line analysis in the edge region (the plane without (001) orientation) of Sample 1-2. Note that data of each measurement point in the profiles shown in FIG. 26A to FIG. 28C was subjected to smoothing processing so as to be the average value of five points including four adjacent points. Note that the distance between measurement points is approximately 0.2 nm; thus, the above five-point average can be regarded as an average value in a region of approximately 0.8 nm.

FIG. 27A, FIG. 27B, and FIG. 27C are each a graph where the vertical axis of FIG. 26A is enlarged; FIG. 27A shows profiles (count number) of cobalt and magnesium, FIG. 27B shows profiles (count number) of cobalt and aluminum, and FIG. 27C shows profiles (count number) of cobalt and nickel. A peak derived from the characteristic X-ray of nickel was not observed in the energy spectrum of the basal region in Sample 1-2. That is, nickel is substantially absent in the basal region of Sample 1-2. Thus, the profile of nickel shown in FIG. 27C is probably derived not from the characteristic X-ray of nickel but from the characteristic X-ray of cobalt which is close to nickel in the energy spectrum.

From the profile in FIG. 26A, the surface was estimated to be a point at a distance of 44.3 nm. Specifically, a region avoiding the vicinity of a portion where the amount of detected cobalt began to increase was determined to be at a distance of 10 to 20 nm in FIG. 26A. A region where the count of cobalt was stable was determined to be at a distance of 94 to 98 nm. A point of 50% of the sum of M_{AVE} and M_{BG} was calculated to be 276.8 counts from the profile of cobalt, and the surface was estimated at 44.3 nm from a calculated regression line.

In FIG. 27A, FIG. 27B, and FIG. 27C, with the direction towards the particle inner portion as the positive direction with reference to the position of the surface estimated above, the peak positions of the additive elements are −0.3 nm for Mg and 3.9 nm for Al. The ratios of the detection intensity of the additive element at the peak position to the average value of the detection intensity of cobalt in the region where the count of cobalt was stable are Mg/Co=0.05 and Al/Co=0.06 in the basal region (the surface having the (001) orientation). The half width of the distribution of magnesium was 2.6 nm. The half width of the distribution of aluminum was 15.2 nm. The aluminum count attenuated to less than or equal to 50% of the peak at a position of 15.4 nm from the surface.

FIG. 28A, FIG. 28B, FIG. 28C, and FIG. 26B are each an enlarged graph where the vertical axis of FIG. 28A is enlarged; FIG. 28B shows profiles (count number) of cobalt and magnesium, FIG. 28B shows profiles (count number) of cobalt and aluminum, and FIG. 28C shows profiles (count number) of cobalt and nickel. Note that a peak derived from the characteristic X-ray of nickel is clearly observed in the energy spectrum of Sample 1-2 in the edge region.

From the profile in FIG. 26B, the surface was estimated to be a point at a distance of 50.5 nm. Specifically, a region avoiding the vicinity of a portion where the amount of detected cobalt began to increase was determined to be at a distance of 10 to 20 nm in FIG. 26B. A region where the count of cobalt is stable was determined to be at a distance of 97 to 100 nm. A point of 50% of the sum of M_{AVE} and M_{BG} was calculated to be 610.2 counts from the profile of cobalt, and the surface was estimated at 50.5 nm from a calculated regression line.

In FIG. 28A, FIG. 28B, and FIG. 28C, with the direction towards the particle inner portion as the positive direction with reference to the position of the surface estimated above, the peak positions of the additive elements are −0.9 nm for Mg, 4.9 nm for Al, and 1.9 nm for Al. Regarding the ratio of the detection intensity of the additive element at the peak position to the average value of the detection intensity of cobalt in the region where the count of cobalt is stable, the intensity ratios in the edge region (the surface without (001) orientation) are Mg/Co=0.11, Al/Co=0.05, and Ni/Co=0.05. The half width of the distribution of magnesium was 4.5 nm, and the half width of the distribution of nickel was 8.1 nm.

As described above, Sample 1-2 demonstrated that the basal region and the edge region each included a region where magnesium was distributed closer to the surface side of the positive electrode active material than aluminum was. It was also confirmed that the edge region included a region where magnesium and nickel were distributed closer to the surface side of the positive electrode active material than aluminum was. Note that in the edge region, it was confirmed that the peak position of magnesium and the peak position of nickel were close to each other, and the distribution of magnesium included a region overlapping with the distribution of nickel.

### Example 2

### <Manufacture of Half Cell>

In this example, coin-type half cells using Sample 1-1, Sample 1-2, Sample 1-3, and Sample 2 formed in Example 1 as positive electrode active materials were manufactured, and evaluation results thereof are described.

First, the positive electrode active material was prepared, and acetylene black (AB) and poly(vinylidene fluoride) (PVDF) were prepared as a conductive material and a binding agent, respectively. The PVDF prepared was one dissolved in advance in N-methyl-2-pyrrolidone (NMP) with a weight ratio of 5%. Next, a slurry was formed by mixing the positive electrode active material, AB, and PVDF at 95:3:2 (weight ratio), and the slurry was applied to a positive electrode current collector of aluminum. As a solvent of the slurry, NMP was used.

Next, after the application of the slurry on the positive electrode current collector, the solvent was volatilized, whereby a positive electrode active material layer was formed over the positive electrode current collector.

After that, pressing treatment was performed with a roller press machine to increase the density of the positive electrode active material layer over the positive electrode current collector. For the positive electrode active material layers formed from Samples 1-1 to 1-3, the linear pressure in the pressing treatment was set to 210 kN/m. For the pressing conditions of the positive electrode active material layer formed from Sample 2, one-time pressing at a linear pressure of 210 kN/m as in Samples 1-1 to 1-3 was employed. Two-time pressing in which pressing at a linear pressure of 1467 kN/m was performed after pressing at a linear pressure of 210 kN/m was also employed.

Through the above process, a positive electrode was obtained. In the positive electrode, the loading amount of the active material was approximately 7 mg/cm².

As an electrolyte solution, a solution in which 1 mol/L of lithium hexafluorophosphate (LiPF₆) was dissolved in a mixture of ethylene carbonate (EC) and diethyl carbonate (DEC) at EC:DEC=3:7 (volume ratio) and in which vinylene carbonate (VC) was mixed at 2 wt % as an additive agent was used. As a separator, a polypropylene porous film was used.

For a negative electrode (counter electrode), a lithium metal was used. A coin-type half cell was manufactured using these components.

A half cell including Sample 1-1 as a positive electrode active material is referred to as Cell 1-1, a half cell including Sample 1-2 as a positive electrode active material is referred to as Cell 1-2, a half cell including Sample 1-3 as a positive electrode active material is referred to as Cell 1-3, and a half cell including Sample 2 as a positive electrode active material is referred to as Cell 2.

### <Charge and Discharge Cycle Test>

Cell 1-1 to Cell 2 described above underwent a charge and discharge cycle test. Six samples were manufactured for each of Cell 1-1 to Cell 1-3, and each cell was subjected to the charge and discharge test under six conditions (first to sixth test conditions). Cell 2 manufactured by pressing once was subjected to charge and discharge tests under the first and second test conditions, and Cell 2 manufactured by pressing twice was subjected to charge and discharge tests under the third to sixth test conditions.

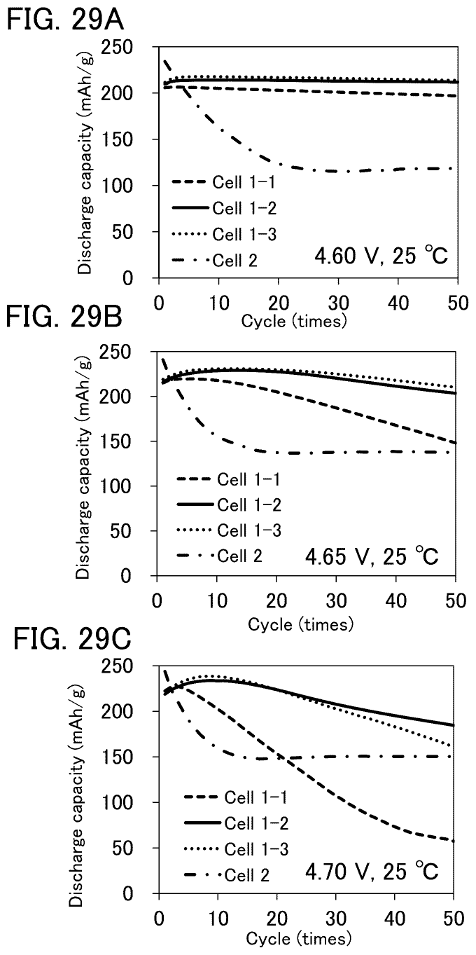

Under the first test condition, charging was performed by constant current charging at 0.5 C to 4.6 V and then constant voltage charging until the current value reaches 0.05 C. Discharging was performed by constant current charging at 0.5 C to 2.5 V or until the discharging time reached 3 hours without reaching 2.5 V, whichever comes first. Note that here, 1 C was 200 mA/g. The temperature of the measurement environment was set to 25° C. In the above manner, charging and discharging were repeated 50 times. FIG. 29A shows the results of the charge and discharge cycle test.

Cell 1-1 to Cell 1-3 exhibited favorable discharge capacity values and favorable charge-discharge cycle performances under the condition where the charge voltage was 4.6 V and the temperature of the measurement environment was 25° C. as shown in FIG. 29A. However, Cell 2 exhibited significant charge and discharge cycle deterioration.

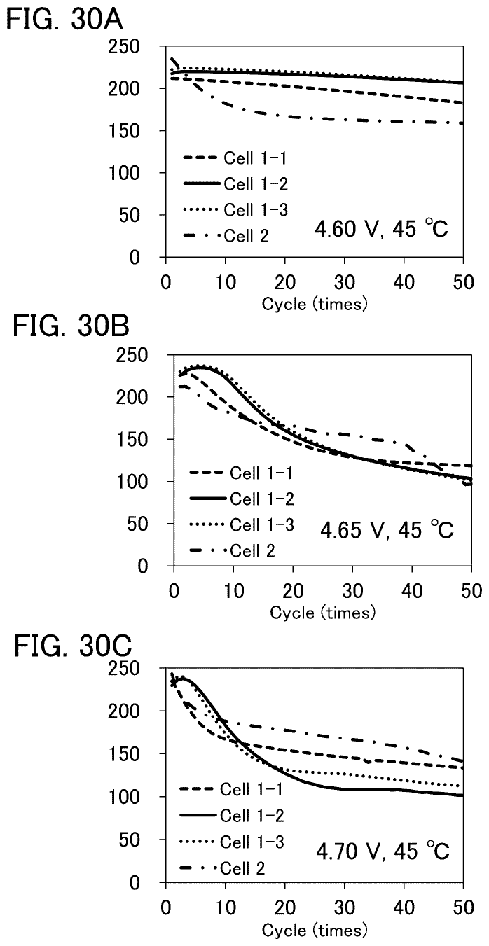

Under the second test condition, charging and discharging were repeated 50 times under the same condition as the first test condition except for the temperature of the measurement environment being 45° C. FIG. 30A shows the results of the charge and discharge cycle test.

Cell 1-1 to Cell 1-3 exhibit favorable discharge capacity values and favorable charge-discharge cycle performances under the condition where the charge voltage was 4.6 V and the temperature of the measurement environment was 45° C. as shown in FIG. 30A. However, Cell 2 exhibits significant charge and discharge cycle deterioration.

Under the third test condition, charging and discharging were repeated 50 times under the same condition as the first test condition except for charging at 4.65 V. FIG. 29B shows the results of the charge and discharge cycle test.

Cell 1-1 to Cell 1-3 exhibited favorable discharge capacity values and favorable charge-discharge cycle performances under the condition where the charge voltage was 4.65 V and the temperature of the measurement environment was 25° C. as shown in FIG. 29B. In particular, Cell 1-2 and Cell 1-3 exhibited excellent cycle performance. However, Cell 2 exhibited significant charge and discharge cycle deterioration.

Under the fourth test condition, charging and discharging were repeated 50 times under the same condition as the third test condition except for the temperature of the measurement environment being 45° C. FIG. 30B shows the results of the charge and discharge cycle test.

Cell 1-1 to Cell 2 exhibited significant charge and discharge cycle deterioration under the condition where the charge voltage was 4.65 V and the temperature of the measurement environment was 45° C. as shown in FIG. 30B.

Under the fifth test condition, charging and discharging were repeated 50 times under the same condition as the first test condition except for charging at 4.70 V. FIG. 29C shows the results of the charge and discharge cycle test.

Cell 1-2 and Cell 1-3 exhibited favorable discharge capacity values and favorable charge-discharge cycle performances under the condition where the charge voltage was 4.7 V and the temperature of the measurement environment was 25° C. as shown in FIG. 29C. In particular, Cell 1-2 had the best cycle performance. However, the other cells exhibit significant charge and discharge cycle deterioration.

Under the sixth test condition, charging and discharging were repeated 50 times under the same condition as the fifth test condition except for the temperature of the measurement environment being 45° C. FIG. 30C shows the results of the charge and discharge cycle test.

Cell 1-1 to Cell 2 exhibited significant charge and discharge cycle deterioration under the condition where the charge voltage was 4.7 V and the temperature of the measurement environment was 45° C. as shown in FIG. 30C.

From the above results, it can be said that the features of Cell 1-1 to Cell 1-3 are necessary to obtain favorable charge-discharge cycle performance under the condition where the temperature of the measurement environment was 25° C. and the charge voltage was higher than or equal to 4.6 V. In other words, it can be considered that the features of Sample 1-1 to Sample 1-3 are necessary.

In addition, it can be said that the features of Cell 1-1 to Cell 1-3 are necessary to obtain favorable charge-discharge cycle performance under the condition where the temperature of the measurement environment was 45° C. and the charge voltage was 4.6 V. In other words, it can be considered that the features of Sample 1-1 to Sample 1-3 are necessary.

Table 4 shows the results of the charge and discharge cycle tests performed on Cell 1-1 to Cell 2 under the first test condition, i.e., at a temperature of the measurement environment of 25

TABLE 4

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 206.4 | 99.3 | 98.3 | 97.3 | 96.3 | 95.4 |
| 1-2 | 214.2 | 100.0 | 99.8 | 99.4 | 99.2 | 98.9 |
| 1-3 | 217.8 | 100.0 | 99.4 | 99.1 | 98.6 | 98.1 |
| 2 | 234.1 | 69.5 | 52.7 | 49.3 | 50.3 | 50.6 |

Table 5 shows the results of the charge and discharge cycle tests performed on Cell 1-1 to Cell 2 under the second test condition, i.e., at a temperature of the measurement environment of 45° C. and a charge voltage of 4.6 V.

TABLE 5

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 211.8 | 98.2 | 95.7 | 92.9 | 89.8 | 86.3 |
| 1-2 | 220.0 | 99.7 | 98.6 | 97.3 | 95.7 | 93.9 |
| 1-3 | 224.1 | 99.4 | 98.1 | 96.4 | 94.5 | 92.4 |
| 2 | 234.9 | 77.5 | 71.1 | 69.3 | 68.4 | 67.6 |

Table 6 shows the results of the charge and discharge cycle tests performed on Cell 1-1 to Cell 2 under the third test condition, i.e., at a temperature of the measurement environment of 25° C. and a charge voltage of 4.65 V.

TABLE 6

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 219.6 | 99.2 | 93.4 | 85.2 | 76.4 | 67.4 |
| 1-2 | 229.1 | 99.8 | 99.4 | 96.2 | 92.3 | 88.8 |
| 1-3 | 230.9 | 99.9 | 99.5 | 97.5 | 94.4 | 91.0 |
| 2 | 240.9 | 64.6 | 57.0 | 57.2 | 57.5 | 57.1 |

Table 7 shows the results of the charge and discharge cycle tests performed on Cell 1-1 to Cell 2 under the fourth test condition, i.e., at a temperature of the measurement environment of 45° C. and a charge voltage of 4.65 V.

TABLE 7

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 227.8 | 81.7 | 64.6 | 56.4 | 53.4 | 52.0 |
| 1-2 | 234.7 | 91.0 | 66.1 | 55.3 | 48.8 | 44.0 |
| 1-3 | 237.1 | 92.6 | 67.1 | 54.9 | 47.9 | 42.8 |
| 2 | 212.3 | 84.4 | 77.9 | 72.5 | 64.8 | 45.6 |

Table 8 shows the results of the charge and discharge cycle tests performed on Cell 1-1 to Cell 2 under the fifth test condition, i.e., at a temperature of the measurement environment of 25° C. and a charge voltage of 4.7 V.

TABLE 8

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 227.4 | 89.0 | 67.4 | 47.2 | 32.2 | 25.2 |
| 1-2 | 233.7 | 99.9 | 95.7 | 88.9 | 83.5 | 79.0 |
| 1-3 | 238.5 | 99.9 | 93.7 | 85.1 | 76.7 | 67.5 |
| 2 | 243.8 | 65.4 | 60.7 | 61.6 | 61.6 | 61.5 |

Table 9 shows the results of the charge and discharge cycle tests performed on Cell 1-1 to Cell 2 under the sixth test condition, i.e., at a temperature of the measurement environment of 45° C. and a charge voltage of 4.7 V.

TABLE 9

| | |
|---|---|
| Maximum | Discharge capacity retention |
| discharge | rate after n cycles (%) |

| | capacity | n = | n = | n = | n = | n = |
|---|---|---|---|---|---|---|
| Cell | (mAh/g) | 10 | 20 | 30 | 40 | 50 |
| 1-1 | 234.7 | 71.1 | 65.8 | 62.2 | 59.5 | 56.9 |
| 1-2 | 237.7 | 77.1 | 53.5 | 45.5 | 45.1 | 42.8 |
| 1-3 | 240.2 | 72.2 | 54.8 | 52.7 | 49.5 | 46.7 |
| 2 | 243.2 | 77.3 | 73.0 | 69.0 | 64.6 | 58.0 |

In Table 4 to Table 9, the discharge capacity retention rate after 10 cycles is the ratio of the 10th discharge capacity to the maximum discharge capacity, the discharge capacity retention rate after 20 cycles is the ratio of the 20th discharge capacity to the maximum discharge capacity, the discharge capacity retention rate after 30 cycles is the ratio of the 30th discharge capacity to the maximum discharge capacity, the discharge capacity retention rate after 40 cycles is the ratio of the 40th discharge capacity to the maximum discharge capacity, and the discharge capacity retention rate after 50 cycles is the ratio of the 50th discharge capacity to the maximum discharge capacity.

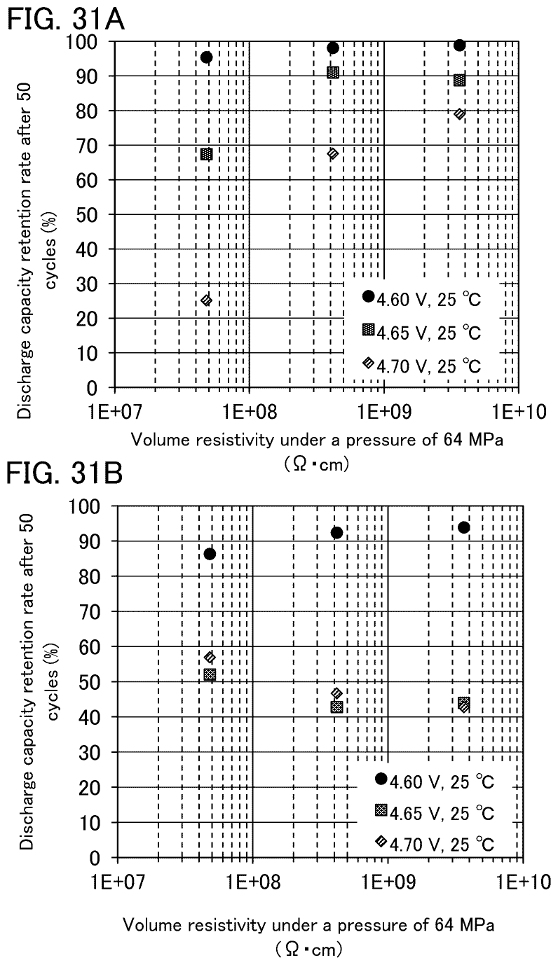

FIG. 31A and FIG. 31B show the relation between the volume resistivity of Sample 1-1 to Sample 1-3 under a pressure of 64 MPa and the discharge capacity retention rate after 50 cycles of a charge and discharge cycle test of cells manufactured from the respective positive electrode active materials. In FIG. 31A, the results of the charge and discharge cycle test of Cell 1-1 to Cell 1-3 when the temperature of the measurement environment was 25° C. correspond to the volume resistivity of Sample 1-1 to Sample 1-3. When the charge voltage was 4.6 V, 4.65 V, and 4.7 V, higher volume resistivity resulted in a higher discharge capacity retention rate after 50 cycles.

In FIG. 31B, the results of the charge and discharge cycle test of Cell 1-1 to Cell 1-3 when the temperature of the measurement environment was 45° C. correspond to the volume resistivity of Sample 1-1 to Sample 1-3. The higher the volume resistivity was, the higher the discharge capacity retention rate after 50 cycles was when the charge voltage was 4.6 V.

The above results show that Sample 1-1 to Sample 1-3 had a powder volume resistivity measured under a pressure of 64 MPa of higher than or equal to 5.0×10³ Ω·cm and lower than or equal to 1.0×10¹² Ω·cm and thus exhibited excellent cycle performance in the charge and discharge cycle test. In particular, it was indicated that Sample 1-2 had a powder volume resistivity measured under a pressure of 64 MPa of higher than or equal to 1.0×10⁹ Ω·cm and lower than or equal to 1.0×10¹⁰ Ω·cm and exhibited the best cycle performance under the condition where the charge voltage was 4.7 V and the temperature of the measurement environment was 25° C.

### REFERENCE NUMERALS

100: positive electrode active material, 100a: surface portion, 100b: inner portion, 101: crystal grain boundary

1. A positive electrode active material comprising cobalt,
wherein a powder volume resistivity of the positive electrode active material measured under a pressure of 64 MPa is higher than or equal to 5.0×10³ Ω·cm and lower than or equal to 1.0×10¹² Ω·cm.

2. The positive electrode active material according to claim 1,
wherein particle size distribution of a powder of the positive electrode active material has a median diameter of greater than or equal to 7 μm and less than or equal to 12 μm, and
wherein the positive electrode active material includes magnesium, nickel, and aluminum.

3. The positive electrode active material according to claim 2,
wherein the positive electrode active material has a layered rock-salt crystal structure belonging to a space group R-3m.

4. The positive electrode active material according to claim 3,
wherein the positive electrode active material includes the magnesium, the nickel, and the aluminum in a surface portion,
wherein the surface portion is a region extending from a surface of the positive electrode active material to a depth of 50 nm or less, and
wherein the positive electrode active material includes a region where the magnesium and the nickel are distributed closer to the surface of the positive electrode active material than the aluminum is when an EDX line analysis in a depth direction is performed.

5. The positive electrode active material according to claim 4,
wherein the surface portion includes a basal region having a surface parallel to a (00/) plane of the crystal structure and an edge region having a surface in a direction intersecting with the (00/) plane, and
wherein in the basal region, a distribution of the aluminum attenuates to 50% of a peak at a depth of 25 nm or less from the surface of the positive electrode active material when an EDX line analysis in a depth direction is performed.

6. A positive electrode comprising the positive electrode active material according to claim 1.

7. A secondary battery comprising the positive electrode according to claim 6.

8. An electronic device comprising the secondary battery according to claim 7.

9. A vehicle comprising the secondary battery according to claim 7.

10. A positive electrode active material comprising cobalt,
wherein a powder volume resistivity of the positive electrode active material measured under a pressure of 64 MPa is higher than or equal to 1.0×10⁷ Ω·cm and lower than or equal to 1.0×10¹⁰ Ω·cm.

11. The positive electrode active material according to claim 10,
wherein particle size distribution of a powder of the positive electrode active material has a median diameter of greater than or equal to 7 μm and less than or equal to 12 μm, and
wherein the positive electrode active material includes magnesium, nickel, and aluminum.

12. The positive electrode active material according to claim 11,
wherein the positive electrode active material has a layered rock-salt crystal structure belonging to a space group R-3m.

13. The positive electrode active material according to claim 12,
wherein the positive electrode active material includes the magnesium, the nickel, and the aluminum in a surface portion,
wherein the surface portion is a region extending from a surface of the positive electrode active material to a depth of 50 nm or less, and
wherein the positive electrode active material includes a region where the magnesium and the nickel are distributed closer to the surface of the positive electrode active material than the aluminum is when an EDX line analysis in a depth direction is performed.

14. The positive electrode active material according to claim 13,
wherein the surface portion includes a basal region having a surface parallel to a (001) plane of the crystal structure and an edge region having a surface in a direction intersecting with the (001) plane, and
wherein in the basal region, a distribution of the aluminum attenuates to 50% of a peak at a depth of 25 nm or less from the surface of the positive electrode active material when an EDX line analysis in a depth direction is performed.

15. A positive electrode comprising the positive electrode active material according to claim 10.

16. A secondary battery comprising the positive electrode according to claim 15.

17. An electronic device comprising the secondary battery according to claim 16.

18. A vehicle comprising the secondary battery according to claim 16.
